(19) United States
(12) Patent Application Publication
(10) Pub. No.: US 2014/0180655 A1
(43) Pub. Date: Jun. 26, 2014

(54) POLARIZATION RAY TRACING TENSOR METHOD

(71) Applicant: The Arizona Board of Regents on Behalf of the University of Arizona, Tucson, AZ (US)

(72) Inventors: Russell A. Chipman, Tucson, AZ (US); Garam Yu, Tucson, AZ (US)

(21) Appl. No.: 14/139,674

(22) Filed: Dec. 23, 2013

Related U.S. Application Data
(60) Provisional application No. 61/848,116, filed on Dec. 21, 2012.

(51) Int. Cl. G06F 17/50

(52) U.S. Cl. CPC G06F 17/5009
USPC 703/2

(57) ABSTRACT

Polarization ray tracing for incoherent light uses a polarization ray trace tensor that can be expressed in local or global coordinates. Ray tracing through a plurality of optical elements or interactions can be performed by cascading polarization ray tracing tensors to obtain a combined polarization ray tracing tensor for the ray path. One or more polarization ray tracing tensors is applied to an input coherence matrix to obtain an output coherence matrix. Polarization ray tracing tensors can be defined based on optical surfaces, Mueller matrices, polarization ray tracing matrices, scattering functions, or other characteristics of optical interfaces and systems.

### CROSS REFERENCE TO RELATED APPLICATION

This application claims the benefit of U.S. Provisional Patent Application 61/848,116, filed Dec. 21, 2012 which is incorporated herein by reference.

### FIELD

The disclosure pertains to ray tracing methods.

### BACKGROUND

Sophisticated computer-aided design systems are currently used by optical engineers in the design and analysis of optical systems. Even designs with complex optical surfaces such as diffractive or aspheric surfaces are relatively straightforward to evaluate. Evaluation of the polarization properties of optical system designs can be done using conventional Jones and Mueller matrices. Available methods are generally unsuitable for evaluation using incoherent light, or for optical systems in which scattering is of interest. Methods and apparatus for use in polarization ray tracing with incoherent light are needed.

### SUMMARY

Optical design systems comprise a memory that stores a plurality of polarization ray tracing tensors and parameters characterizing an optical system. A processor is coupled to the memory and configured to determine an output coherence matrix based on at least one polarization ray tracing tensor and an input coherence matrix. In some cases, the processor is configured to transform a polarization ray tracing tensor from a local coordinate system to a global coordinate system, wherein the local coordinate system is based on an s-polarization direction, a p-polarization direction, and an incident propagation direction. In typical embodiments, the processor is configured to cascade a plurality of polarization ray tracing tensors to form a cascaded polarization ray tracing tensor. The output coherence matrix is then determined as a product of the cascaded ray tracing tensor and the input coherence matrix. Polarization ray tracing tensors can be determined based on surface characteristics and associated Fresnel reflection or transmission coefficients, Mueller matrices, scattering functions, polarization ray tracing matrices. Polarization ray tracing tensors can be obtained in local or global coordinate systems and transformed between coordinate systems. For collimated rays, individual polarizing ray tracing tensors can be added, and the summed tensor applied to the input coherence matrix to obtain the output coherence matrix.

These and other features are set forth below with reference to the accompanying drawings.

### BRIEF DESCRIPTION OF THE DRAWINGS

FIG. 1 illustrates polarization raytracing through a triplet followed by a lens barrel. A collimated grid of rays propagates through the triplet and scatters from the lens barrel before reaching a detector plane.

FIG. 2 illustrates ray propagation along a z axis and reflecting from an aluminum coated surface.

FIGS. 3A-3B illustrate a volume of water droplets in air which scatters an incident collimated beam of light. The incident beam of light is plotted as dark arrows and some of the individual scattering ray paths are shown as lighter arrows.

FIG. 4 shows s and p polarization reflection coefficients as a function of scattering angle.

FIG. 5 is a nine-by-nine grid of a detector having a surface normal along an x-axis. Each grid area corresponds to a summation of polarization ray tracing tensors along the x-axis over the associated sets of scattering ray paths through the water droplets.

FIG. 6 is a graph showing 3D degree of polarization (DOP) for each exiting coherence matrix at a detector. The x-axis indicates the pixel number. The 3D DOP shows that the exiting light is mostly unpolarized.

FIG. 7 is a graph of polarization of each 2D Stokes vector calculated at each pixel on a detector. The values indicate that the exiting light is mostly unpolarized.

FIG. 8 is a graph showing S₀ components of an exiting 2D Stokes vectors at each pixel.

FIG. 9 is a graph of diattenation of scattered light as calculated. For positive values, the s-polarization has greater scattering amplitudes than the p-polarization.

FIG. 10 is a graph showing 2D components of the exiting 2D Stokes vectors at each pixel.

FIG. 11 shows exiting light polarization vectors on a detector plane as solid lines; linearly polarized light with polarization vectors at 45° are shown as dashed lines.

FIG. 12 illustrates a representative polarization ray tracing method.

FIG. 13 illustrates a method for tracing a plurality of rays through an optical system to obtain an output coherence matrix by cascading polarization ray tracing tensors.

FIG. 14 illustrates a method of establishing a polarization ray tracing tensor in local and global coordinates based on Fresnel coefficients.

FIG. 15 illustrates a method of establishing a polarization ray tracing tensor based on a polarization ray trace matrix.

FIG. 16 illustrates a method of establishing a polarization ray tracing tensor based on a Mueller matrix.

FIG. 17 illustrates a representative computing device configured for polarization ray tracing using polarization ray tracing tensors.

FIG. 18 illustrates a distributed (cloud-based) computing environment for implement the disclosed methods.

FIG. 19 illustrates a representative computing environment for implementing the disclosed methods.

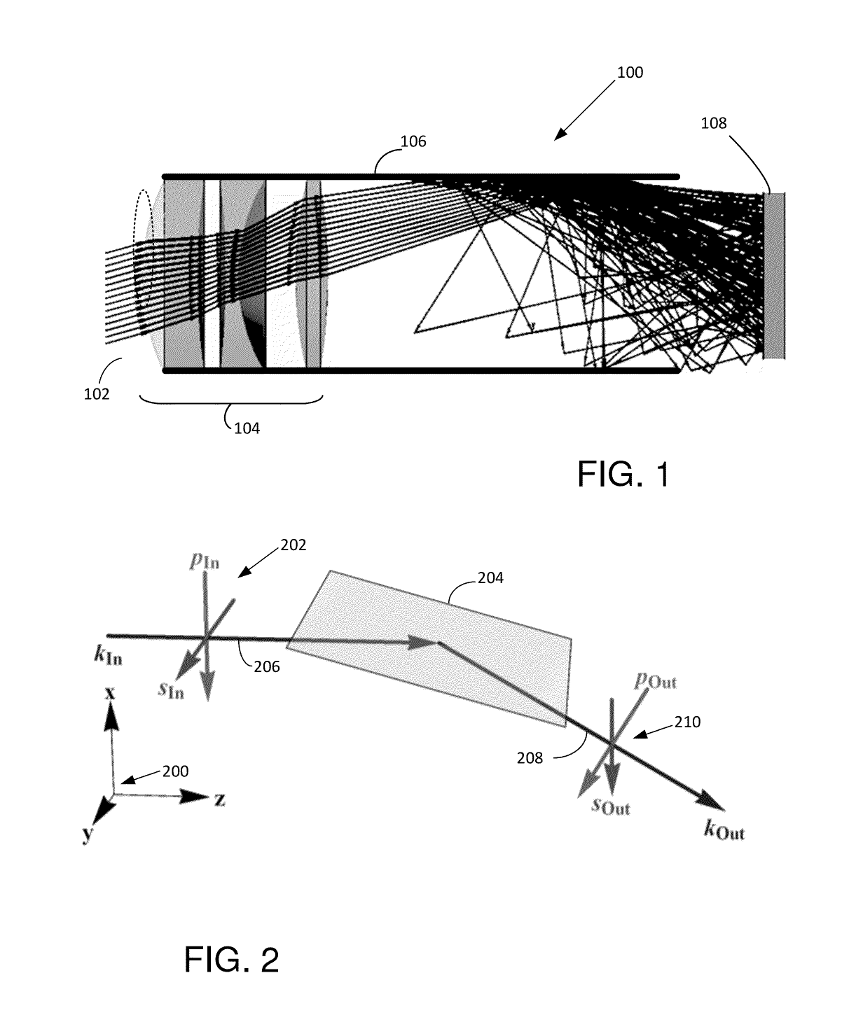

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

As used herein, light refers to propagating electromagnetic radiation in a wavelength range of interest such as visible, infrared, ultraviolet or other range or ranges.

In the disclosed examples, polarization ray tracing methods are described with reference to polarization-based parameters arranged as vectors (one-dimensional matrices), square matrices, tensors, or other arrangements. Polarization ray tracing can be conveniently performed and implemented in various types of computation hardware such as personal computers, lap tops, hand held communication devices, tablets or other devices. However, the same or similar polarization ray tracing can be produced using corresponding linear combinations of polarization-based parameters, without arrangement in a particular fashion such as, for example, as a square matrix. In addition, in the examples, full tensors, matrices, and vectors are generally used, but in some applications, only portions are needed to evaluate the optical arrangements of interest.

### 1.1 Introduction

The calculation of the phase and optical path length of wavefronts through an optical system is an example of coherent ray tracing, ray tracing which determines the phase of the resulting light. If the calculation is capable of determining the phase of coherent light, then it is also suitable for determining the propagation and image formation of incoherent light through the optical system as well.

For some optical system simulations, the phase of the light is not needed or may not even be well defined. In many illumination systems, the light is polychromatic. The light may take many different paths to a particular point on the illuminated surface. The effects of interference between the different polychromatic beams are not observable because the optical path length differences are many waves. The illuminated spot is well approximated by the sum of intensities rather than the sum of amplitudes, or when polarization is considered, by the sum of Stokes parameters rather than the sum of Jones vectors.

A similar situation occurs in the stray light simulation. Consider a telescope in orbit looking at the surface of the earth. The sun is outside the field of view, but some sunlight may enter the telescope tube. By simulating the light scattering from the telescope baffles and other mechanical structures, as well as the reflections and refractions of the optical elements, the stray light due to the sun can be estimated at the focal plane, typically by Monte Carlo methods. The optical path lengths of the stray light rays incident on a particular pixel may vary by centimeters, even meters. Thus, even though the optical path lengths and phases of the rays may be calculated, the individual phases of a randomly generated set of rays is not particularly useful for simulating stray light measurements of the telescopes. By replacing the sun with a laser shining into the telescope barrel, a speckle pattern will result at the focal plane instead. Although this speckle pattern depends on the phases of all the light converging on a point, the speckle pattern cannot be simulated in detail since the speckle distribution depends on the roughness of all the baffles' surfaces. The detailed topography of the mechanical surfaces will never be known to an accuracy of a tenth of a wave. So even for this coherent laser light, the incoherent ray trace is appropriate for determining the flux levels at the focal plane.

Coherent ray tracing and incoherent ray tracing refer to the coherence and incoherence of the calculation respectively, and not the coherence and incoherence of the light. A coherent ray trace calculates phases and wavefronts, and can simulate image formation and point spread functions. An incoherent calculation may not necessarily calculate the phase of the ray path; sometimes only a bidirectional reflectance distribution function or a Mueller matrix may be known for a scattering surface, and the phase change is not known or calculated at ray intercepts.

Polarization ray tracing methods that can be used with coherent or incoherent light and that are suitable for stray light calculations are disclosed. For non-polarizing optical systems, eight independent parameters—amplitude, phase, three for diattenuation, and three for retardance—are required to describe polarization characteristics of ray paths through an optical system. One common representation is the Jones matrix to relate incident and exiting polarization states. The general case, with depolarizing elements or scattering, requires sixteen independent parameters—amplitude, three for diattenuation, three for retardance, and additional nine degrees of freedom for depolarization—for a complete polarization characterization of the system.

To provide mathematical description of the polarization properties of light, a coherence matrix of an electric field vector in global coordinates is used. A polarization ray tracing tensor is defined. Algorithms to calculate the tensor from surface amplitude coefficients defined in local coordinates, a Mueller matrix defined in its local coordinates, and a three-by-three polarization ray tracing matrix defined in global coordinates are derived. The polarization ray tracing tensor is defined in global coordinates and is used to ray trace incoherent light through optical systems with depolarizing surfaces. The polarization ray tracing tensor operates on the incident electric field's coherence matrix and returns the exiting coherence matrix in global coordinates. Therefore, such methods are suitable for scattered light ray tracing and incoherent addition of light.

For the case of parallel entering and parallel exiting beams of light, polarization ray tracing tensors can be added to get the exiting coherence matrix. Therefore, the combined polarization ray tracing tensor is defined for a specific incident propagation vector but not restricted by the exiting propagation vector. Polarization ray tracing tensor calculus through a volume of scattering particles is presented as an example.

### 1.2 The Coherence Matrix

The coherence matrix ³Φ of a light beam contains all the measurable 2^{nd} order correlation information about the state of polarization, including intensity, of an ensemble of electromagnetic waves at a point. This positive semidefinite Hermitian 3×3 matrix is defined as

$${}^{3} Φ = < E ( t ) ⊗ {E}^{†} ( t ) >= ( \begin{matrix}{φ}_{xx} & {φ}_{xy} & {φ}_{xz} \\ {φ}_{yx} & {φ}_{yy} & {φ}_{yz} \\ {φ}_{zx} & {φ}_{zy} & {φ}_{zz}\end{matrix} ) = ( \begin{matrix}< {E}_{x} ( t ) {E}_{x}^{*} ( t ) > & < {E}_{x} ( t ) {E}_{y}^{*} ( t ) > & < {E}_{x} ( t ) {E}_{z}^{*} ( t ) > \\ < {E}_{y} ( t ) {E}_{x}^{*} ( t ) > & < {E}_{y} ( t ) {E}_{y}^{*} ( t ) > & < {E}_{y} ( t ) {E}_{z}^{*} ( t ) > \\ < {E}_{z} ( t ) {E}_{x}^{*} ( t ) > & < {E}_{z} ( t ) {E}_{y}^{*} ( t ) > & < {E}_{z} ( t ) {E}_{z}^{*} ( t ) >\end{matrix} ) \qquad ( 1.2 .1 )$$

where E(t) is the instantaneous electric field vector; E^{†}(t) is the transpose conjugate of E(t); [symbol] stands for the Kronecker product; Eᵢ*(t) is the complex conjugate of Eᵢ(t); i=x, y, z; the brackets indicate the time average of the components

$${φ}_{ij} = < {E}_{i} ( t ) {E}_{j}^{*} ( t ) >= {lim}_{T -> ∝} \frac{1}{T} {\int }_{0}^{T} {E}_{i} ( t ) {E}_{j}^{*} ( t ) d t . \qquad ( 1.2 .2 )$$

Under the assumption that the Eᵢ(t) are stationary and ergodic, the brackets can alternatively be considered as ensemble averaging of E(t) [symbol] E^{†}(t).

In general, the time of measurement T is much larger than the coherence time for the partially coherent electromagnetic waves. Therefore, ³Φ is suited to describe coherency of quasimonochromatic, partially polarized light.

Conventional, two-dimensional (2D) Stokes parameters are defined on a plane perpendicular to the propagation vector of the light, using specific local coordinates. For a plane wave propagating along the z-axis

$${}^{3} Φ = ( \begin{matrix}{φ}_{xx} & {φ}_{xy} & 0 \\ {φ}_{yx} & {φ}_{yy} & 0 \\ 0 & 0 & 0\end{matrix} ) . \qquad ( 1.2 .3 )$$

Thus the Stokes parameters associated with this plane wave are

S₀=φₓₓ+φ_{yy}, S₁=φₓₓ−φ_{yy}, S₂=φ_{xy}+φ_{yx}, S₃=i(φ_{yx}−φ_{xy}), (1.2.4)

and the degree of polarization (DoP) for this plane wave is

$$DoP = \frac{\sqrt{{s}_{1}^{z} + {s}_{2}^{z} + {s}_{3}^{z}}}{{S}_{0}} = \frac{\sqrt{{φ}_{xx}^{2} - 2 {φ}_{xx} {φ}_{yy} + {φ}_{yy}^{z} + 4 {φ}_{xy} {φ}_{yx}}}{{φ}_{xx} + {φ}_{yy}} . \qquad ( 1.2 .5 )$$

Similar relations can be developed for plane waves propagating in other directions.

The three-dimensional degree of polarization ³DoP is defined by using the coherence matrix

$${}^{3} DoP = \vert \sqrt{\frac{1}{2} ( \frac{3 ‖ \text{?} \text{?}}{‖ \text{?} \text{?}} - 1 )} \vert , \\ \text{?} \text{indicates text missing or illegible when filed} \qquad ( 1.2 .6 )$$

wherein the Euclidean norms are

∥³Φ∥₀=Tr(³Φ)=φₓₓ+φ_{yy}+φ_{zz},

∥³Φ∥₂=\sqrt{(Σ_{i,j=1}³|φ_{i,j}|²)}. (1.2.7)

The 3D degree of polarization ³DoP takes into account not only the degree of polarization of the mean polarization ellipse but also the stability of the plane that contains the instantaneous components of the electric field of the wave. Unpolarized light with a fixed propagation vector direction has 2D degree of polarization DoP=0 with ³DoP=0.5. Further discussions on ³DoP can be found in J. J. Gil, “Polarimetric characterization of light and media,” Eur. Phys. J. Appl. Phys. 40, pp. 1-47 (2007), which is incorporated herein by reference.

1.3 Projection of the Coherence Matrix onto Arbitrary Planes

To understand the 2^{nd} order correlations that result when two wavefronts with two different electric fields overlap at a point, each electric field vector is converted to a coherence matrix ³Φ,

³Φ₁=<E₁(t) [symbol] E₁^{†}(t)>, ³Φ₂=<E₂(t) [symbol] E₂^{†}(t)>. (1.3.1)

Coherence matrices can be added since the addition operator and integral operator commute. Therefore, the total coherence matrix of the two wavefronts is

³Φ_{Total}=³Φ₁+³Φ₂=<E₁(t) [symbol] E₁^{†}(t)>+<E₂(t) [symbol] E₂^{†}(t)>. (1.3.2)

The advantage of ³Φ_{Total} is that it provides incoherent addition of two wavefronts in global coordinates with complete polarization information along all three axes. Therefore, this method is particularly useful for incoherent addition of multiple wavefronts with different propagation directions. Scattered light wavefronts do not follow law of reflection, refraction or diffraction but have various distributions of propagation directions depending on the type of scattering at the ray intercept. Since each coherence matrix ³Φᵢ is defined in global coordinates, simple summation of coherence matrices provides the incoherent addition of wavefronts with different propagation directions. 3D electric field vectors or the coherence matrices contain full information along x, y, and z directions. However, polarization state is defined on a 2D plane and majority of polarization analysis or intensity measurements are done on a 2D plane. Therefore, an algorithm to find a projection of the coherence matrix ³Φ onto an arbitrary plane is necessary.

Projecting ³Φ_{Total} onto an arbitrary plane of interest is done by using proper local coordinates on the plane \hat{x}_{Loc} and ŷ_{Loc}, which are perpendicular to the plane's surface normal \hat{η}={ηₓ, η_{y}, η_{z}}

\hat{x}_{Loc}⊥\hat{η} and ŷ_{Loc}=\hat{η}×\hat{x}_{Loc}. (1.3.3)

Then, projected ³Φ_{Total} onto a plane spanned by \hat{x}_{Loc} and ŷ_{Loc} is

$${}_{}^{3}{Φ}{}_{Proj , Loc}^{} = ( \begin{matrix}{\hat{x}}_{Loc} {}_{}^{3}{Φ}{}_{Total}^{} {\hat{x}}_{Loc}^{t} & {\hat{x}}_{Loc} {}_{}^{3}{Φ}{}_{Total}^{} {\hat{y}}_{Loc}^{t} & 0 \\ {\hat{y}}_{Loc} {}_{}^{3}{Φ}{}_{Total}^{} {\hat{x}}_{Loc} & {\hat{y}}_{Loc} {}_{}^{3}{Φ}{}_{Total}^{} {\hat{y}}_{Loc}^{t} & 0 \\ 0 & 0 & 0\end{matrix} ) . \qquad ( 1.3 .4 )$$

This matrix is written in its local coordinates as Jones matrices are often written in s and p local coordinates. Using Eq. (1.4.13), ³Φ_{Proj.Loc} can be written in global coordinates,

³Φ_{Proj}=R³Φ_{Proj.Loc}R⁻¹. (1.3.5)
where R={\hat{x}_{Loc}, ŷ_{Loc}, \hat{η}}^{t}.

### 1.4 Definition of Polarization Ray Tracing Tensor

The coherence matrix ³Φ is defined in global coordinates and thus allows incoherent addition of light by simple addition. Therefore, an operator which deals with ³Φ in global coordinates can provide a new tool for incoherent ray tracing through depolarizing optical systems.

A Polarization Ray Tracing Tensor (T=t_{i,j,k,l}) is a 3×3×3×3 tensor which describes a depolarizing or non-depolarizing polarization interaction at a ray intercept or surface, or propagation through a sequence of depolarizing or non-depolarizing interactions,

$$T = ( \begin{matrix}( \begin{matrix}{t}_{1 , 1 , 1 , 1} & {t}_{1 , 1 , 1 , 2} & {t}_{1 , 1 , 1 , 3} \\ {t}_{1 , 1 , 2 , 1} & {t}_{1 , 1 , 2 , 2} & {t}_{1 , 1 , 2 , 3} \\ {t}_{1 , 1 , 3 , 1} & {t}_{1 , 1 , 3 , 2} & {t}_{1 , 1 , 3 , 3}\end{matrix} ) & ( \begin{matrix}{t}_{1 , 2 , 1 , 1} & {t}_{1 , 2 , 1 , 2} & {t}_{1 , 2 , 1 , 3} \\ {t}_{1 , 2 , 2 , 1} & {t}_{1 , 2 , 2 , 2} & {t}_{1 , 2 , 2 , 3} \\ {t}_{1 , 2 , 3 , 1} & {t}_{1 , 2 , 3 , 2} & {t}_{1 , 2 , 3 , 3}\end{matrix} ) & ( \begin{matrix}{t}_{1 , 3 , 1 , 1} & {t}_{1 , 3 , 1 , 2} & {t}_{1 , 3 , 1 , 3} \\ {t}_{1 , 3 , 2 , 1} & {t}_{1 , 3 , 2 , 2} & {t}_{1 , 3 , 2 , 3} \\ {t}_{1 , 3 , 3 , 1} & {t}_{1 , 3 , 3 , 2} & {t}_{1 , 3 , 3 , 3}\end{matrix} ) \\ ( \begin{matrix}{t}_{2 , 1 , 1 , 1} & {t}_{2 , 1 , 1 , 2} & {t}_{2 , 1 , 1 , 3} \\ {t}_{2 , 1 , 2 , 1} & {t}_{2 , 1 , 2 , 2} & {t}_{2 , 1 , 2 , 3} \\ {t}_{2 , 1 , 3 , 1} & {t}_{2 , 1 , 3 , 2} & {t}_{2 , 1 , 3 , 3}\end{matrix} ) & ( \begin{matrix}{t}_{2 , 2 , 1 , 1} & {t}_{2 , 2 , 1 , 2} & {t}_{2 , 2 , 1 , 3} \\ {t}_{2 , 2 , 2 , 1} & {t}_{2 , 2 , 2 , 2} & {t}_{2 , 2 , 2 , 3} \\ {t}_{2 , 2 , 3 , 1} & {t}_{2 , 2 , 3 , 2} & {t}_{2 , 2 , 3 , 3}\end{matrix} ) & ( \begin{matrix}{t}_{2 , 3 , 1 , 1} & {t}_{2 , 3 , 1 , 2} & {t}_{2 , 3 , 1 , 3} \\ {t}_{2 , 3 , 2 , 1} & {t}_{2 , 3 , 2 , 2} & {t}_{2 , 3 , 2 , 3} \\ {t}_{2 , 3 , 3 , 1} & {t}_{2 , 3 , 3 , 2} & {t}_{2 , 3 , 3 , 3}\end{matrix} ) \\ ( \begin{matrix}{t}_{3 , 1 , 1 , 1} & {t}_{3 , 1 , 1 , 2} & {t}_{3 , 1 , 1 , 3} \\ {t}_{3 , 1 , 2 , 1} & {t}_{3 , 1 , 2 , 2} & {t}_{3 , 1 , 2 , 3} \\ {t}_{3 , 1 , 3 , 1} & {t}_{3 , 1 , 3 , 2} & {t}_{3 , 1 , 3 , 3}\end{matrix} ) & ( \begin{matrix}{t}_{3 , 2 , 1 , 1} & {t}_{3 , 2 , 1 , 2} & {t}_{3 , 2 , 1 , 3} \\ {t}_{3 , 2 , 2 , 1} & {t}_{3 , 2 , 2 , 2} & {t}_{3 , 2 , 2 , 3} \\ {t}_{3 , 2 , 3 , 1} & {t}_{3 , 2 , 3 , 2} & {t}_{3 , 2 , 3 , 3}\end{matrix} ) & ( \begin{matrix}{t}_{3 , 3 , 1 , 1} & {t}_{3 , 3 , 1 , 2} & {t}_{3 , 3 , 1 , 3} \\ {t}_{3 , 3 , 2 , 1} & {t}_{3 , 3 , 2 , 2} & {t}_{3 , 3 , 2 , 3} \\ {t}_{3 , 3 , 3 , 1} & {t}_{3 , 3 , 3 , 2} & {t}_{3 , 3 , 3 , 3}\end{matrix} )\end{matrix} ) \qquad ( 1.4 .1 )$$

T operates on the incident coherence matrix

(³Φ_{Out})_{i,j}=Σ_{k,l}t_{i,j,k,l}(³Φ_{In})_{k,l} (1.4.2)

yielding the output coherence matrix where i, j, k, l=x, y, z, i.e.,

$${}_{}^{3}{Φ}{}_{Out}^{} = ( \begin{matrix}{φ}_{Out , xx} & {φ}_{Out , xy} & {φ}_{Out , xz} \\ {φ}_{Out , yx} & {φ}_{Out , yy} & {φ}_{Out , yz} \\ {φ}_{Out , zx} & {φ}_{Out , zy} & {φ}_{Out , zz}\end{matrix} ) , \\ {}_{}^{3}{Φ}{}_{In}^{} = ( \begin{matrix}{φ}_{In , xx} & {φ}_{In , xy} & {φ}_{In , xz} \\ {φ}_{In , yx} & {φ}_{In , yy} & {φ}_{In , yz} \\ {φ}_{In , zx} & {φ}_{In , zy} & {φ}_{In , zz}\end{matrix} ) . \qquad ( 1.4 .3 )$$

The coordinates for the input and output coherence matrices may be either local or global coordinates.

One significant advantage of the polarization ray tracing tensor T over a polarization ray tracing matrix P is that T can describe depolarizing optical systems. Therefore having an index that indicates how depolarizing a given tensor is can be meaningful. Analogous to how the Mueller depolarization index is defined, the depolarization index (DI) of the T can be defined when the T tensor is associated with a single exiting propagation vector. This DI is defined as

$$DI = \frac{\vert T - {T}_{ID} \vert}{\vert T \vert} .$$

where the Euclidean distance between T_{ID} and T is the sum of each of the Euclidean distances of t_{i,j}'s,

|T−T_{ID}|=Σ_{i,j=1}³SVD_{i,j},

and SVD_{i,j} is the maximum singular value of (T−T_{ID})_{i,j}. The Euclidean distance between T_{ID} and the zero tensor is

$$\vert {T}_{ID} \vert = \frac{1}{3} ( \begin{matrix}1 & 0 & 0 \\ 0 & 1 & 0 \\ 0 & 0 & 1\end{matrix} ) .$$

For a ray propagating through an optical system with multiple surfaces, each surface in the system contributes a polarization ray tracing tensor. A cumulative polarization ray tracing tensor is obtained for that particular ray by multiplying the sequence of tensors.

FIG. 2 shows an example optical system with a triplet 104 followed by a lens barrel 106. A collimated grid of rays 102 enters the optical system at a large angle off the axis of the optical system, propagates through the triplet 104, and then much of the beam scatters off the lens barrel 106 before reaching a detector 108. Each ray in the grid has a polarization ray tracing tensor at each ray intercept. In order to ray trace through the entire system, each ray's polarization ray tracing tensors are cascaded to get a grid of cumulative polarization ray tracing tensors at the detector.

Considering the primary property of the polarization ray tracing tensor shown in Eq. (1.4.2) and its dimensions (1×3×3×3), cascading two polarization ray tracing tensors T₁ and T₂ is

(Tₜₒₜₐₗ)_{i,j,m,n}=Σ_{k,l=1}³t_{2,i,j,k,l}t_{1,k,l,m,n}, (1.4.4)

and the exiting coherence matrix after the T_{Total} is

$${( {}_{}^{3}{Φ}{}_{out}^{} )}_{i , j} = {\sum }_{m , n = 1}^{3} {( {T}_{total} )}_{i , j , m , n} {( {}_{}^{3}{Φ}{}_{In}^{} )}_{m , n} = {\sum }_{m , n = 1}^{3} {\sum }_{k , l = 1}^{3} {t}_{2 , i , j , k , l} {{t}_{1 , k , l , m , n} ( {}_{}^{3}{Φ}{}_{In}^{} )}_{m , n} . \qquad ( 1.4 .5 )$$

Similarly, the (i, j, v, w) component of the T_{Total} for a ray propagating through N ray intercepts can be calculated by cascading summations,

(T_{Total})_{i,j,v,w}=Σ_{k,l=1}³Σ_{m,n=1}³ . . . Σ_{r,s=1}³Σ_{t,u=1}³t_{N,i,j,k,l}t_{N-1,k,l,m,n} . . . t_{3,p,q,r,s}t_{2,r,s,t,u}t_{1,t,u,v,w}. (1.4.6)

When a collimated N-by-N grid of rays with a propagation vector \hat{k}_{In} enters an optical system with N surfaces, each ray's cumulative polarization ray tracing tensor can be added to get the exiting coherence matrix for the incoherent addition of the exiting rays,

(³Φ_{Out})_{i,j}=Σ_{v,w=1}³{(Σ_{q=1}^{N}^{²}T_{Total,q})_{i,j,v,w}(³Φ_{In})_{v,w}}, (1.4.7)

where q stands for the ray index, q=1, 2, 3, . . . , N². Since all the rays in the incident grid have the same ³Φ_{In}, all the cumulative polarization ray tracing tensors can be added and then applied to ³Φ_{In} to get ³Φ_{Out}. Note that the combined polarization ray tracing tensor (Σ_{q=1}^{N}^{²}T_{Total,q}) is defined for a single \hat{k}_{In} but is not restricted for the exiting propagation vector direction. Thus, the combined polarization ray tracing tensor can accommodate multiple exiting propagation vector directions, and this is one of the main advantages of using the tensor method in stray light calculus.

If the incident grid of rays were not collimated, then the exiting coherence matrix of each ray is calculated using Eq. (1.4.2) and then added incoherently in order to get the incoherent addition of the exiting rays,

φ_{Out,i,j}=Σ_{q=1}^{N}^{²}{Σ_{v,w=1}³(T_{Total,q})_{i,j,v,w}(³Φ_{In})_{v,w}}. (1.4.8)

### 1.5.1 A Polarization Ray Tracing Tensor for a Non-Depolarizing Ray Intercept

Although the main purpose of using the polarization ray tracing tensor T is incoherent ray tracing through depolarizing optical systems, T can be used for the incoherent ray tracing through non-depolarizing optical systems. In this section, two ways of calculating the tensor are presented; one is using amplitude coefficients, defined in the surface local coordinates. The other is using the three-by-three polarization ray tracing matrix, defined in global coordinates.

1.5.2 A Polarization Ray Tracing Tensor from Surface Amplitude Coefficients

If surface reflection or transmission coefficients are given in {ŝ_{In}, \hat{p}_{In}} local coordinates defined based on propagation direction, and s- and p-polarization directions for the light propagating along \hat{k}_{In}, the exiting electric field vector projected onto the local coordinate plane perpendicular to \hat{k}_{Out} is

$$( \begin{matrix}{E}_{Out , s} \\ {E}_{Out , p}\end{matrix} ) = ( \begin{matrix}{α}_{ss} & {α}_{ps} \\ {α}_{sp} & {α}_{pp}\end{matrix} ) ( \begin{matrix}{E}_{In , s} \\ {E}_{In , p}\end{matrix} ) . \qquad ( 1.4 .9 )$$

Therefore, the exiting coherence matrix in the local coordinates (³Φ_{Out.Loc}) is

φ_{Out.Loc,1,1}=αₛₛαₛₛ*φ_{In,ss}+αₛₛαₚₛ*φ_{In,sp}+αₚₛαₛₛ*φ_{In,ps}+αₚₛαₚₛ*φ_{In,pp},

φ_{Out.Loc,1,2}=αₛₛαₛₚ*φ_{In,ss}+αₛₛαₚₚ*φ_{In,sp}+αₚₛαₛₚ*φ_{In,ps}+αₚₛαₚₚ*φ_{In,pp},

φ_{Out.Loc,2,1}=αₛₚαₛₛ*φ_{In,ss}+αₛₚαₚₛ*φ_{In,sp}+αₚₚαₛₛ*φ_{In,ps}+αₚₚαₚₛ*φ_{In,pp},

φ_{Out.Loc,2,2}=αₛₚαₛₚ*φ_{In,ss}+αₛₚαₚₚ*φ_{In,sp}+αₚₚαₛₚ*φ_{In,ps}+αₚₚαₚₚ*φ_{In,pp},

φ_{Out.Loc,1,3}=φ_{Out.Loc,2,3}=φ_{Out.Loc,3,1}=φ_{Out.Loc,3,2}=φ_{Out.Loc,3,3}=0, (1.4.10)
where φ_{In,i,j}=<Eᵢ(t)Eⱼ*(t)> and i,j=s,p.

Eq. (1.4.10) can be written in terms of the polarization ray tracing tensor in local {ŝ_{In}, \hat{p}_{In}, \hat{k}_{In}} and {ŝ_{Out}, \hat{p}_{Out}, \hat{k}_{Out}} coordinates, T_{Loc},

$$\begin{matrix}{{(}^{3} {Φ}_{Out , Loc} )}_{i , j} = {( \begin{matrix}{φ}_{Out , Loc , 1 , 1} & {φ}_{Out , Loc , 1 , 2} & 0 \\ {φ}_{Out , Loc , 2 , 1} & {φ}_{Out , Loc , 2 , 2} & 0 \\ 0 & 0 & 0\end{matrix} )}_{i , j} \\ = \text{?} {{t}_{Loc , i , j , k , l} {(}^{3} {Φ}_{In , Loc} )}_{k , l} \\ = {\sum }_{k , l} {( \begin{matrix}{( \begin{matrix}{α}_{ss} {α}_{ss}^{*} & {α}_{ss} {α}_{ps}^{*} & 0 \\ {α}_{ps} {α}_{ss}^{*} & {α}_{ps} {α}_{ps}^{*} & 0 \\ 0 & 0 & 0\end{matrix} )}_{k , l} & {( \begin{matrix}{α}_{ss} {α}_{sp}^{*} & {α}_{ss} {α}_{pp}^{*} & 0 \\ {α}_{ps} {α}_{sp}^{*} & {α}_{ps} {α}_{pp}^{*} & 0 \\ 0 & 0 & 0\end{matrix} )}_{k , l} & ( 0 ) \\ {( \begin{matrix}{α}_{sp} {α}_{ss}^{*} & {α}_{sp} {α}_{ps}^{*} & 0 \\ {α}_{pp} {α}_{ss}^{*} & {α}_{pp} {α}_{ps}^{*} & 0 \\ 0 & 0 & 0\end{matrix} )}_{k , l} & {( \begin{matrix}{α}_{sp} {α}_{sp}^{*} & {α}_{sp} {α}_{pp}^{*} & 0 \\ {α}_{pp} {α}_{sp}^{*} & {α}_{pp} {α}_{pp}^{*} & 0 \\ 0 & 0 & 0\end{matrix} )}_{k , l} & ( 0 ) \\ ( 0 ) & ( 0 ) & ( 0 )\end{matrix} )}_{i , j} \\ ( \begin{matrix}{φ}_{In , ss} & {φ}_{In , sp} & 0 \\ {φ}_{In , ps} & {φ}_{In , pp} & 0 \\ 0 & 0 & 0\end{matrix} \text{?}\end{matrix} \\ where \\ ( 0 ) = ( \begin{matrix}0 & 0 & 0 \\ 0 & 0 & 0 \\ 0 & 0 & 0\end{matrix} ) . \\ \text{?} \text{indicates text missing or illegible when filed} \qquad ( 1.4 .11 )$$

The polarization ray tracing tensor in global coordinates (T) can be calculated by applying proper coordinate transformation from the local coordinates to global coordinates using rotation matrices. Using unit vectors ŝ_{In}, \hat{p}_{In}, and \hat{k}_{In} along s-polarization direction, p-polarization direction, and direction of propagation vectors defined as basis vectors of the rotation matrices, the incident coherence matrix (³Φ_{In}) in global coordinates is

³Φ_{In}=R_{In}³Φ_{In.Loc}R_{In}⁻¹, (1.4.12)

where R_{In}={ŝ_{In}, \hat{p}_{In}, \hat{k}_{In}}^{t}. Thus, the incident coherence matrix in local coordinates (³Φ_{In.Loc}) can be written as a function of φ_{In,i,j}'S

$${}_{}^{3}{Φ}{}_{In , Loc}^{} = ( \begin{matrix}{φ}_{In , ss} & {φ}_{In , sp} & 0 \\ {φ}_{In , ps} & {φ}_{In , pp} & 0 \\ 0 & 0 & 0\end{matrix} ) = {R}_{In}^{- 1} {}_{}^{3}{Φ}{}_{In}^{} {R}_{In} . \qquad ( 1.4 .13 )$$

Similarly, the exiting coherence matrix in local coordinates (³Φ_{Out.Loc}) is

³Φ_{Out.Loc}=R_{Out}⁻¹³Φ_{Out}R_{Out}, (1.4.14)

where R_{Out}={ŝ_{Out}, \hat{p}_{Out}, \hat{k}_{Out}}^{t}.

Inserting Eq. (1.4.13) and (1.4.14) to Eq. (1.4.11),

(R_{Out}⁻¹³Φ_{Out}R_{Out})_{i,j}=Σ_{k,l}t_{Loc,i,j,k,l}(R_{In}⁻¹³Φ_{In}R_{In})_{k,l}. (1.4.15)

Therefore, the exiting coherence matrix in global coordinates is

(³Φ_{Out})_{i,j}=[R_{Out}{Σ_{k,l}t_{Loc,i,j,k,l}(R_{In}⁻¹³Φ_{In}R_{In})_{k,l}}R_{Out}⁻¹]_{i,j}. (1.4.16)

Comparing Eq. (1.4.2) and (1.4.16), the components of the polarization ray tracing tensor in global coordinates (t_{i,j,k,l}) are the corresponding coefficients of (³Φ_{In})_{k,l} for (³Φ_{Out})_{i,j} using Eq. (1.4.16). Table 1 shows the polarization ray tracing tensor (T) in global coordinates as a function of amplitude coefficients in local coordinates and the incident and exiting local coordinate basis vectors for,

ŝ_{In}={s_{In,x},s_{In,y},s_{In,z}}, \hat{p}_{In}={p_{In,x},p_{In,y},p_{In,z}}, ŝ_{Out}={s_{Out,x},s_{Out,y},s_{Out,z}}, \hat{p}_{Out}={p_{Out,x},p_{Out,y},p_{Out,z}},

c_{x,1}=(αₚₚp_{In,x}+αₚₛs_{In,x}), c_{x,2}=(αₛₚp_{In,x}+αₛₛs_{In,x}), c_{y,1}=(αₚₚp_{In,y}+αₚₛs_{In,y}), c_{y,2}=(αₛₚp_{In,y}+αₛₛs_{In,y}), c_{z,1}=(αₚₚp_{In,z}+αₚₛs_{In,z}), c_{z,2}=(αₛₚp_{In,z}+αₛₛs_{In,z}),

d_{x,1}=(p_{Out,x}αₚₚ*+s_{Out,x}αₛₚ*), d_{x,2}=(p_{Out,x}αₚₛ*+s_{Out,x}αₛₛ*), d_{y,1}=(p_{Out,y}αₚₚ*+s_{Out,y}αₛₚ*), d_{y,2}=(p_{Out,y}αₚₛ*+s_{Out,y}αₛₛ*), d_{z,1}=(p_{Out,z}αₚₚ*+s_{Out,z}αₛₚ*), d_{z,2}=(p_{Out,z}αₚₛ*+s_{Out,z}αₛₛ*). (1.4.17)

TABLE 1
A polarization ray tracing tensor in global coordinates as a function of
amplitude coefficients in local coordinates. Each T_{i,j} shows a
three-by-three matrix component of the tensor.

| | | | |
|---|---|---|---|
| T_{1,1} | (c_{x,1}p_{Out,x} + c_{x,2}s_{Out,x}) | (c_{x,1}p_{Out,x} + c_{x,2}s_{Out,x}) | (c_{x,1}p_{Out,x} + |
| | | | c_{x,2}s_{Out,x}) |
| | (d_{x,1}p_{In,x} + d_{x,2}s_{In,x}) | (d_{x,1}p_{In,y} + d_{x,2}s_{In,y}) | (d_{x,1}p_{In,z} + |
| | | | d_{x,2}s_{In,z}) |
| | (c_{y,1}p_{Out,x} + c_{y,2}s_{Out,x}) | (c_{y,1}p_{Out,x} + c_{y,2}s_{Out,x}) | (c_{y,1}p_{Out,x} + |
| | | | c_{y,2}s_{Out,x}) |
| | (d_{x,1}p_{In,x} + d_{x,2}s_{In,x}) | (d_{x,1}p_{In,y} + d_{x,2}s_{In,y}) | (d_{x,1}p_{In,z} + |
| | | | d_{x,2}s_{In,z}) |
| | (c_{z,1}p_{Out,x} + c_{z,2}s_{Out,x}) | (c_{z,1}p_{Out,x} + c_{z,2}s_{Out,x}) | (c_{z,1}p_{Out,x} + |
| | | | c_{z,2}s_{Out,x}) |
| | (d_{x,1}p_{In,x} + d_{x,2}s_{In,x}) | (d_{x,1}p_{In,y} + d_{x,2}s_{In,y}) | (d_{x,1}p_{In,z} + |
| | | | d_{x,2}s_{In,z}) |
| T_{1,2} | (c_{x,1}p_{Out,x} + c_{x,2}s_{Out,x}) | (c_{x,1}p_{Out,x} + c_{x,2}s_{Out,x}) | (c_{x,1}p_{Out,x} + |
| | | | c_{x,2}s_{Out,x}) |
| | (d_{y,1}p_{In,x} + d_{y,2}s_{In,x}) | (d_{y,1}p_{In,y} + d_{y,2}s_{In,y}) | (d_{y,1}p_{In,z} + |
| | | | d_{y,2}s_{In,z}) |
| | (c_{y,1}p_{Out,x} + c_{y,2}s_{Out,x}) | (c_{y,1}p_{Out,x} + c_{y,2}s_{Out,x}) | (c_{y,1}p_{Out,x} + |
| | | | c_{y,2}s_{Out,x}) |
| | (d_{y,1}p_{In,x} + d_{y,2}s_{In,x}) | (d_{y,1}p_{In,y} + d_{y,2}s_{In,y}) | (d_{y,1}p_{In,z} + |
| | | | d_{y,2}s_{In,z}) |
| | (c_{z,1}p_{Out,x} + c_{z,2}s_{Out,x}) | (c_{z,1}p_{Out,x} + c_{z,2}s_{Out,x}) | (c_{z,1}p_{Out,x} + |
| | | | c_{z,2}s_{Out,x}) |
| | (d_{y,1}p_{In,x} + d_{y,2}s_{In,x}) | (d_{y,1}p_{In,y} + d_{y,2}s_{In,y}) | (d_{y,1}p_{In,z} + |
| | | | d_{y,2}s_{In,z}) |
| T_{1,3} | (c_{x,1}p_{Out,x} + c_{x,2}s_{Out,x}) | (c_{x,1}p_{Out,x} + c_{x,2}s_{Out,x}) | (c_{x,1}p_{Out,x} + |
| | | | c_{x,2}s_{Out,x}) |
| | (d_{z,1}p_{In,x} + d_{z,2}s_{In,x}) | (d_{z,1}p_{In,y} + d_{z,2}s_{In,y}) | (d_{z,1}p_{In,z} + |
| | | | d_{z,2}s_{In,z}) |
| | (c_{y,1}p_{Out,x} + c_{y,2}s_{Out,x}) | (c_{y,1}p_{Out,x} + c_{y,2}s_{Out,x}) | (c_{y,1}p_{Out,x} + |
| | | | c_{y,2}s_{Out,x}) |
| | (d_{z,1}p_{In,x} + d_{z,2}s_{In,x}) | (d_{z,1}p_{In,y} + d_{z,2}s_{In,y}) | (d_{z,1}p_{In,z} + |
| | | | d_{z,2}s_{In,z}) |
| | (c_{z,1}p_{Out,x} + c_{z,2}s_{Out,x}) | (c_{z,1}p_{Out,x} + c_{z,2}s_{Out,x}) | (c_{z,1}p_{Out,x} + |
| | | | c_{z,2}s_{Out,x}) |
| | (d_{z,1}p_{In,x} + d_{z,2}s_{In,x}) | (d_{z,1}p_{In,y} + d_{z,2}s_{In,y}) | (d_{z,1}p_{In,z} + |
| | | | d_{z,2}s_{In,z}) |
| T_{2,1} | (c_{x,1}p_{Out,y} + c_{x,2}s_{Out,y}) | (c_{x,1}p_{Out,y} + c_{x,2}s_{Out,y}) | (c_{x,1}p_{Out,y} + |
| | | | c_{x,2}s_{Out,y}) |
| | (d_{x,1}p_{In,x} + d_{x,2}s_{In,x}) | (d_{x,1}p_{In,y} + d_{x,2}s_{In,y}) | (d_{x,1}p_{In,z} + |
| | | | d_{x,2}s_{In,z}) |
| | (c_{y,1}p_{Out,y} + c_{y,2}s_{Out,y}) | (c_{y,1}p_{Out,y} + c_{y,2}s_{Out,y}) | (c_{y,1}p_{Out,y} + |
| | | | c_{y,2}s_{Out,y}) |
| | (d_{x,1}p_{In,x} + d_{x,2}s_{In,x}) | (d_{x,1}p_{In,y} + d_{x,2}s_{In,y}) | (d_{x,1}p_{In,z} + |
| | | | d_{x,2}s_{In,z}) |
| | (c_{z,1}p_{Out,y} + c_{z,2}s_{Out,y}) | (c_{z,1}p_{Out,y} + c_{z,2}s_{Out,y}) | (c_{z,1}p_{Out,y} + |
| | | | c_{z,2}s_{Out,y}) |
| | (d_{x,1}p_{In,x} + d_{x,2}s_{In,x}) | (d_{x,1}p_{In,y} + d_{x,2}s_{In,y}) | (d_{x,1}p_{In,z} + |
| | | | d_{x,2}s_{In,z}) |
| T_{2,2} | (c_{x,1}p_{Out,y} + c_{x,2}s_{Out,y}) | (c_{x,1}p_{Out,y} + c_{x,2}s_{Out,y}) | (c_{x,1}p_{Out,y} + |
| | | | c_{x,2}s_{Out,y}) |
| | (d_{y,1}p_{In,x} + d_{y,2}s_{In,x}) | (d_{y,1}p_{In,y} + d_{y,2}s_{In,y}) | (d_{y,1}p_{In,z} + |
| | | | d_{y,2}s_{In,z}) |
| | (c_{y,1}p_{Out,y} + c_{y,2}s_{Out,y}) | (c_{y,1}p_{Out,y} + c_{y,2}s_{Out,y}) | (c_{y,1}p_{Out,y} + |
| | | | c_{y,2}s_{Out,y}) |
| | (d_{y,1}p_{In,x} + d_{y,2}s_{In,x}) | (d_{y,1}p_{In,y} + d_{y,2}s_{In,y}) | (d_{y,1}p_{In,z} + |
| | | | d_{y,2}s_{In,z}) |
| | (c_{z,1}p_{Out,y} + c_{z,2}s_{Out,y}) | (c_{z,1}p_{Out,y} + c_{z,2}s_{Out,y}) | (c_{z,1}p_{Out,y} + |
| | | | c_{z,2}s_{Out,y}) |
| | (d_{y,1}p_{In,x} + d_{y,2}s_{In,x}) | (d_{y,1}p_{In,y} + d_{y,2}s_{In,y}) | (d_{y,1}p_{In,z} + |
| | | | d_{y,2}s_{In,z}) |
| T_{2,3} | (c_{x,1}p_{Out,y} + c_{x,2}s_{Out,y}) | (c_{x,1}p_{Out,y} + c_{x,2}s_{Out,y}) | (c_{x,1}p_{Out,y} + |
| | | | c_{x,2}s_{Out,y}) |
| | (d_{z,1}p_{In,x} + d_{z,2}s_{In,x}) | (d_{z,1}p_{In,y} + d_{z,2}s_{In,y}) | (d_{z,1}p_{In,z} + |
| | | | d_{z,2}s_{In,z}) |
| | (c_{y,1}p_{Out,y} + c_{y,2}s_{Out,y}) | (c_{y,1}p_{Out,y} + c_{y,2}s_{Out,y}) | (c_{y,1}p_{Out,y} + |
| | | | c_{y,2}s_{Out,y}) |
| | (d_{z,1}p_{In,x} + d_{z,2}s_{In,x}) | (d_{z,1}p_{In,y} + d_{z,2}s_{In,y}) | (d_{z,1}p_{In,z} + |
| | | | d_{z,2}s_{In,z}) |
| | (c_{z,1}p_{Out,y} + c_{z,2}s_{Out,y}) | (c_{z,1}p_{Out,y} + c_{z,2}s_{Out,y}) | (c_{z,1}p_{Out,y} + |
| | | | c_{z,2}s_{Out,y}) |
| | (d_{z,1}p_{In,x} + d_{z,2}s_{In,x}) | (d_{z,1}p_{In,y} + d_{z,2}s_{In,y}) | (d_{z,1}p_{In,z} + |
| | | | d_{z,2}s_{In,z}) |
| T_{3,1} | (c_{x,1}p_{Out,z} + c_{x,2}s_{Out,z}) | (c_{x,1}p_{Out,z} + c_{x,2}s_{Out,z}) | (c_{x,1}p_{Out,z} + |
| | | | c_{x,2}s_{Out,z}) |
| | (d_{x,1}p_{In,x} + d_{x,2}s_{In,x}) | (d_{x,1}p_{In,y} + d_{x,2}s_{In,y}) | (d_{x,1}p_{In,z} + |
| | | | d_{x,2}s_{In,z}) |
| | (c_{y,1}p_{Out,z} + c_{y,2}s_{Out,z}) | (c_{y,1}p_{Out,z} + c_{y,2}s_{Out,z}) | (c_{y,1}p_{Out,z} + |
| | | | c_{y,2}s_{Out,z}) |
| | (d_{x,1}p_{In,x} + d_{x,2}s_{In,x}) | (d_{x,1}p_{In,y} + d_{x,2}s_{In,y}) | (d_{x,1}p_{In,z} + |
| | | | d_{x,2}s_{In,z}) |
| | (c_{z,1}p_{Out,z} + c_{z,2}s_{Out,z}) | (c_{z,1}p_{Out,z} + c_{z,2}s_{Out,z}) | (c_{z,1}p_{Out,z} + |
| | | | c_{z,2}s_{Out,z}) |
| | (d_{x,1}p_{In,y} + d_{x,2}s_{In,y}) | (d_{x,1}p_{In,y} + d_{x,2}s_{In,y}) | (d_{x,1}p_{In,z} + |
| | | | d_{x,2}s_{In,z}) |
| T_{3,2} | (c_{x,1}p_{Out,z} + c_{x,2}s_{Out,z}) | (c_{x,1}p_{Out,z} + c_{x,2}s_{Out,z}) | (c_{x,1}p_{Out,z} + |
| | | | c_{x,2}s_{Out,z}) |
| | (d_{y,1}p_{In,x} + d_{y,2}s_{In,x}) | (d_{y,1}p_{In,y} + d_{y,2}s_{In,y}) | (d_{y,1}p_{In,z} + |
| | | | d_{y,2}s_{In,z}) |
| | (c_{y,1}p_{Out,z} + c_{y,2}s_{Out,z}) | (c_{y,1}p_{Out,z} + c_{y,2}s_{Out,z}) | (c_{y,1}p_{Out,z} + |
| | | | c_{y,2}s_{Out,z}) |
| | (d_{y,1}p_{In,x} + d_{y,2}s_{In,x}) | (d_{y,1}p_{In,y} + d_{y,2}s_{In,y}) | (d_{y,1}p_{In,z} + |
| | | | d_{y,2}s_{In,z}) |
| | (c_{z,1}p_{Out,z} + c_{z,2}s_{Out,z}) | (c_{z,1}p_{Out,z} + c_{z,2}s_{Out,z}) | (c_{z,1}p_{Out,z} + |
| | | | c_{z,2}s_{Out,z}) |
| | (d_{y,1}p_{In,y} + d_{y,2}s_{In,y}) | (d_{y,1}p_{In,z} + d_{y,2}s_{In,z}) | (d_{y,1}p_{In,z} + |
| | | | d_{y,2}s_{In,z}) |
| T_{3,3} | (c_{x,1}p_{Out,z} + c_{x,2}s_{Out,z}) | (c_{x,1}p_{Out,z} + c_{x,2}s_{Out,z}) | (c_{x,1}p_{Out,z} + |
| | | | c_{x,2}s_{Out,z}) |
| | (d_{z,1}p_{In,x} + d_{z,2}s_{In,x}) | (d_{z,1}p_{In,y} + d_{z,2}s_{In,y}) | (d_{z,1}p_{In,z} + |
| | | | d_{z,2}s_{In,z}) |
| | (c_{y,1}p_{Out,z} + c_{y,2}s_{Out,z}) | (c_{y,1}p_{Out,z} + c_{y,2}s_{Out,z}) | (c_{y,1}p_{Out,z} + |
| | | | c_{y,2}s_{Out,z}) |
| | (d_{z,1}p_{In,x} + d_{z,2}s_{In,x}) | (d_{z,1}p_{In,y} + d_{z,2}s_{In,y}) | (d_{z,1}p_{In,z} + |
| | | | d_{z,2}s_{In,z}) |
| | (c_{z,1}p_{Out,z} + c_{z,2}s_{Out,z}) | (c_{z,1}p_{Out,z} + c_{z,2}s_{Out,z}) | (c_{z,1}p_{Out,z} + |
| | | | c_{z,2}s_{Out,z}) |
| | (d_{z,1}p_{In,x} + d_{z,2}s_{In,x}) | (d_{z,1}p_{In,y} + d_{z,2}s_{In,y}) | (d_{z,1}p_{In,z} + |
| | | | d_{z,2}s_{In,z}) |

In Mathematica, the tensor can be found by using the following command

t_{i,j,k,l}=Coefficient[φ_{Out,i,j},φ_{In,k,l}], (1.4.18)

where φ_{Out,i,j} is calculated from Eq. (1.4.16).

### 1.5.3 Polarization Ray Tracing Tensors From 3 by 3 Polarization Ray Tracing Matrices

This section presents an algorithm to calculate the polarization ray tracing tensor T that corresponds to a three-by-three polarization ray tracing matrix P. This conversion is straightforward since the P matrix is already defined in global coordinates. The exiting electric field vector from the P matrix is

$$( \begin{matrix}{E}_{Out , x} \\ {E}_{Out , y} \\ {E}_{Out , z}\end{matrix} ) = ( \begin{matrix}{P}_{1 , 1} & {P}_{1 , 2} & {P}_{1 , 3} \\ {P}_{2 , 1} & {P}_{2 , 2} & {P}_{2 , 3} \\ {P}_{3 , 1} & {P}_{3 , 2} & {P}_{3 , 3}\end{matrix} ) ( \begin{matrix}{E}_{In , x} \\ {E}_{In , y} \\ {E}_{In , z}\end{matrix} ) = ( \begin{matrix}{P}_{1 , 1} {E}_{In , x} + {P}_{1 , 2} {E}_{In , y} + {P}_{1 , 3} {E}_{In , z} \\ {P}_{2 , 1} {E}_{In , x} + {P}_{2 , 2} {E}_{In , y} + {P}_{2 , 3} {E}_{In , z} \\ {P}_{3 , 1} {E}_{In , x} + {P}_{3 , 2} {E}_{In , y} + {P}_{3 , 3} {E}_{In , z}\end{matrix} ) \qquad ( 1.4 .19 )$$

Using Eq. (1.2.1), ³Φ_{Out} can be calculated and comparing the result with Eq. (1.4.2), the relationship of the polarization ray tracing tensor to the P matrix is

t_{i,j,k,l}=P_{i,k}P*_{j,l}, (1.4.20)

where i, j, k, l=1, 2, 3. Again, a set of Ts can be added for a collimated grid of incident rays using Eq. (1.4.7).

If a polarization ray tracing tensor T is associated with a single {\hat{k}_{In}, \hat{k}_{Out}} pair and is representing a non-depolarizing incoherent ray trace, an associated three-by-three polarization ray tracing matrix P can be uniquely defined to within an unknown absolute phase φ₀. Since the tensor T is associated with intensity values of the electric field vector while the P matrix is associated with the amplitude values of the electric field vector, the absolute phase of the P matrix is lost when transforming P into T. First, the norm of each element in P matrix is calculated. Then, the phase of each element is calculated relative to φ₀. Expressing P's elements in polar coordinates, the matrix becomes

$$P = ( \begin{matrix}{P}_{1 , 1} & {P}_{1 , 2} & {P}_{1 , 3} \\ {P}_{2 , 1} & {P}_{2 , 2} & {P}_{2 , 3} \\ {P}_{3 , 1} & {P}_{3 , 2} & {P}_{3 , 3}\end{matrix} ) = ( \begin{matrix}{p}_{1 , 1} {e}^{{iφ}_{1 , 1}} & {p}_{1 , 2} {e}^{{iφ}_{1 , 2}} & {p}_{1 , 3} {e}^{{iφ}_{1 , 2}} \\ {p}_{2 , 1} {e}^{{iφ}_{2 , 1}} & {p}_{2 , 2} {e}^{{iφ}_{2 , 2}} & {p}_{2 , 3} {e}^{{iφ}_{2 , 3}} \\ {p}_{3 , 1} {e}^{{iφ}_{3 , 1}} & {p}_{3 , 2} {e}^{{iφ}_{3 , 2}} & {p}_{3 , 3} {e}^{{iφ}_{3 , 3}}\end{matrix} ) . \qquad ( 1.4 .21 )$$

From Eq. (1.4.20), diagonal elements in the tensor gives the norm of the P matrix elements

t_{i,i,j,j}=P_{i,j}P_{i,j}*=|p_{i,j}|², (1.4.22)

therefore,

p_{i,j}=\sqrt{t_{i,i,j,j}}. (1.4.23)

The phase of P_{i,j} can be calculated by choosing a reference; if p_{i,j}≠0 for a particular i and j, its phase can be set to the absolute phase, φ_{i,j}=φ₀ and all the other phases are defined relative to the absolute phase. From Eq. (1.4.20)

$${φ}_{k , l} = [ \begin{matrix}i \{ Log ( \frac{{t}_{i , k , j , l}}{{p}_{i , j} {p}_{k , l}} ) \} + {φ}_{0} & if {p}_{k , l} \neq 0 \\ 0 & if {p}_{k , l} = 0\end{matrix} . \qquad ( 1.4 .24 )$$

For example, if p_{1,1}≠0

$${φ}_{1 , 1} = {φ}_{0} \\ and \\ {φ}_{k , l} = [ \begin{matrix}i \{ Log ( \frac{\text{?}}{\text{?} \text{?}} ) \} + {φ}_{0} & if {p}_{k , l} \neq 0 \\ 0 & if {p}_{k , l} = 0\end{matrix} . \\ \text{?} \text{indicates text missing or illegible when filed} \qquad ( 1.4 .25 )$$

Using Eq. (1.4.23) and (1.4.24), the P matrix is uniquely defined with the absolute phase φ₀.

### 1.5.4 Polarization Ray Tracing Tensor Calculation

This section provides a non-depolarizing example tensor calculation where incident light propagating along an axis 206 reflects from an aluminum coated surface 204 with the following parameters (shown in FIG. 2):

$${\hat{k}}_{In} = \{ 0 , 0 , 1 \} , {\hat{k}}_{Out} = \{ - \frac{1}{2} , 0 , \frac{\sqrt{3}}{2} \} , n = 0.769 + 6.08 i , \qquad ( 1.4 .26 )$$

where n is Aluminum's refractive index at 500 nm. The reflected light propagates along an axis 208. Input and reflected beams are described with reference to coordinating systems 202, 210 that are based on s- and p-polarization directions with respect to an arbitrary coordinating system 200. The corresponding amplitude reflection coefficients α_{i,j}'s are the Fresnel reflection coefficients,

$$( \begin{matrix}{α}_{ss} & {α}_{ps} \\ {α}_{sp} & {α}_{pp}\end{matrix} ) = ( \begin{matrix}{r}_{s} & 0 \\ 0 & {r}_{p}\end{matrix} ) = ( \begin{matrix}- 0.986 + 0.0819 i & 0 \\ 0 & 0.377 - 0.806 i\end{matrix} ) . \qquad ( 1.4 .27 )$$

The polarization ray tracing tensor in local coordinates is

$${T}_{Loc} ( \begin{matrix}( \begin{matrix}0.980 & 0 & 0 \\ 0 & 0 & 0 \\ 0 & 0 & 0\end{matrix} ) & ( \begin{matrix}0 & - 0.438 - 0.764 i & 0 \\ 0 & 0 & 0 \\ 0 & 0 & 0\end{matrix} ) & ( 0 ) \\ ( \begin{matrix}0 & 0 & 0 \\ - 0.438 + 0.764 i & 0 & 0 \\ 0 & 0 & 0\end{matrix} ) & ( \begin{matrix}0 & 0 & 0 \\ 0 & 0.791 & 0 \\ 0 & 0 & 0\end{matrix} ) & ( 0 ) \\ ( 0 ) & ( 0 ) & ( 0 )\end{matrix} ) , \\ {R}_{In} = ( \begin{matrix}1 & 0 & 0 \\ 0 & 1 & 0 \\ 0 & 0 & 1\end{matrix} ) , \\ {R}_{Out} = ( \begin{matrix}0 & - \frac{\sqrt{3}}{2} & - \frac{1}{2} \\ 1 & 0 & 0 \\ 0 & - \frac{1}{2} & \frac{\sqrt{3}}{2}\end{matrix} ) . \qquad ( 1.4 .28 )$$

Since the incident propagation vector is along the z-axis, any incident electric field vector can be written as E_{In}={E_{In,x}, E_{In,y}, 0}. Therefore, the incident coherence matrix in local coordinates and the one in global coordinates are the same

$${}_{}^{3}{Φ}{}_{In , Loc}^{} = {}_{}^{3}{Φ}{}_{In}^{} = ( \begin{matrix}{Φ}_{In , xx} & {Φ}_{In , xy} & 0 \\ {Φ}_{In , yx} & {Φ}_{In , yy} & 0 \\ 0 & 0 & 0\end{matrix} ) . \qquad ( 1.4 .29 )$$

Using Eq. (1.4.16),

$${}_{}^{3}{Φ}{}_{Out}^{} = ( \begin{matrix}0.593 {φ}_{In , xx} & ( - 0.380 + 0.661 i ) {φ}_{In , yx} & 0.343 {φ}_{In , xx} \\ ( - 0.380 - 0.661 i ) {φ}_{In , yx} & 0.980 {φ}_{In , yy} & {( - 0.219 - 0.382 i )}_{In , yx} \\ 0.343 {φ}_{In , xx} & ( - 0.219 + 0.382 i ) {φ}_{In , yx} & 0.198 {φ}_{In , xx}\end{matrix} ) \qquad ( 1.4 .30 )$$

Therefore, the polarization ray tracing tensor in global coordinates is

$$T = ( \begin{matrix}( \begin{matrix}0.593 & 0 & 0 \\ 0 & 0 & 0 \\ 0 & 0 & 0\end{matrix} ) & ( \begin{matrix}0 & - 0.380 + 0.661 i & 0 \\ 0 & 0 & 0 \\ 0 & 0 & 0\end{matrix} ) & ( \begin{matrix}0.343 & 0 & 0 \\ 0 & 0 & 0 \\ 0 & 0 & 0\end{matrix} ) \\ ( \begin{matrix}0 & 0 & 0 \\ - 0.380 - 0.661 i & 0 & 0 \\ 0 & 0 & 0\end{matrix} ) & ( \begin{matrix}0 & 0 & 0 \\ 0 & 0.980 & 0 \\ 0 & 0 & 0\end{matrix} ) & ( \begin{matrix}0 & 0 & 0 \\ - 0.219 - 0.382 i & 0 & 0 \\ 0 & 0 & 0\end{matrix} ) \\ ( \begin{matrix}0.343 & 0 & 0 \\ 0 & 0 & 0 \\ 0 & 0 & 0\end{matrix} ) & ( \begin{matrix}0 & - 0.219 + 0.382 i & 0 \\ 0 & 0 & 0 \\ 0 & 0 & 0\end{matrix} ) & ( \begin{matrix}0.198 & 0 & 0 \\ 0 & 0 & 0 \\ 0 & 0 & 0\end{matrix} )\end{matrix} ) \qquad ( 1.4 .31 )$$

Using the algorithm in Three-dimensional polarization ray-tracing calculus I: definition and diattenuation, G. Yun, K. Crabtree, and R. Chipman, Appl. Opt. 50, 2855-2865 (2011), which is incorporated herein by reference, a three-dimensional polarization ray tracing matrix can be calculated for this example,

$$P = ( \begin{matrix}0.327 - 0.698 i & 0 & - 0.5 \\ 0 & - 0.986 + 0.082 i & 0 \\ 0.189 - 0.403 i & 0 & 0.866\end{matrix} ) , \qquad ( 1.4 .32 )$$

and the exiting electric field vector is

$${E}_{Out} = P {E}_{In} = ( \begin{matrix}( 0.327 - 0.698 i ) {E}_{In , x} \\ ( - 0.986 + 0.082 i ) {E}_{In , y} \\ ( 0.189 - 0.403 i ) {E}_{In , x}\end{matrix} ) , \qquad ( 1.4 .33 )$$

which gives the same ³Φ_{Out} as in Eq. (1.4.30).
1.6.1 A Polarization Ray Tracing Tensor for a Ray Intercept with Scattering

In order to ray trace through optical systems with scattering surfaces or depolarizing surfaces, Fresnel coefficients or amplitude coefficients do not provide sufficient information to describe polarization characteristics of such interactions. In general, a Mueller matrix or a Mueller matrix bidirectional reflectance distribution function BRDF is used to describe depolarizing optical surfaces (see, for example, Depolarization of diffusely reflecting manmade objects, B. DeBoo, J. Sasian, R. Chipman, Applied Optics, vol. 44, no. 26, pp. 5434-5445 (Sep. 10, 2005)), which is incorporated herein by reference. In this section, a method to transform the Mueller matrix into a polarization ray tracing tensor when the incident and exiting propagation vector, a Mueller matrix, and its local coordinates for the incident and exiting space are given. The logic is analogous to the previous section and Eq. (1.4.2) and (1.4.18) still holds. The only differences are the intermediate steps in getting a relationship between ³Φ_{Out} and ³Φ_{In}.

As shown in Eq. (1.2.4), 2D Stokes parameters are related to the coherence matrix elements. Similar to Jones vectors, 2D Stokes parameters are defined in local coordinates. Therefore, the tensor can be calculated by representing the incident and exiting Stokes vectors in global coordinate coherence matrix elements. 2D Mueller calculus shows

$${S}_{Out} = ( \begin{matrix}{S}_{Out , 0} \\ {S}_{Out , 1} \\ {S}_{Out , 2} \\ {S}_{Out , 3}\end{matrix} ) = M \\ {S}_{In} = ( \begin{matrix}{m}_{0 , 0} & {m}_{0 , 1} & {m}_{0 , 2} & {m}_{0 , 3} \\ {m}_{1 , 0} & {m}_{1 , 1} & {m}_{1 , 2} & {m}_{1 , 3} \\ {m}_{2 , 0} & {m}_{2 , 1} & {m}_{2 , 2} & {m}_{2 , 3} \\ {m}_{3 , 0} & {m}_{3 , 1} & {m}_{3 , 2} & {m}_{3 , 3}\end{matrix} ) ( \begin{matrix}{S}_{In , 0} \\ {S}_{In , 1} \\ {S}_{In , 2} \\ {S}_{In , 3}\end{matrix} ) . \qquad ( 1.5 .1 )$$

The incident Stokes vector has a coherence matrix in the incident local coordinates {\hat{x}_{In}, ŷ_{In}, \hat{k}_{In}},

$${}_{}^{3}{Φ}{}_{In , Loc}^{} = ( \begin{matrix}\frac{\text{?} + \text{?}}{2} & \frac{\text{?} + i \text{?}}{2} & 0 \\ \frac{\text{?} - i \text{?}}{2} & \frac{{S}_{In .0} - {S}_{In .1}}{2} & 0 \\ 0 & 0 & 0\end{matrix} ) , \\ \text{?} \text{indicates text missing or illegible when filed} \qquad ( 1.5 .2 )$$

and the exiting Stokes vector has a coherence matrix in the exiting local coordinates {\hat{x}_{Out}, ŷ_{Out}, \hat{k}_{Out}},

$${ }^{3} {Φ}_{Out , Loc} = ( \begin{matrix}\frac{\text{?} + \text{?}}{2} & \frac{\text{?} + i \text{?}}{2} & 0 \\ \frac{\text{?} - i \text{?}}{2} & \frac{\text{?} - \text{?}}{2} & 0 \\ 0 & 0 & 0\end{matrix} ) \\ where \\ { }^{3} {Φ}_{Out , Loc , 1 , 1} = \frac{\begin{matrix}\text{?} ( \text{?} + \text{?} ) + \text{?} ( {m}_{0 , 1} + {m}_{1 , 1} ) + \\ \text{?} ( {m}_{0 , 2} + {m}_{2 , 2} ) + \text{?} ( {m}_{0 , 3} + {m}_{1 , 3} )\end{matrix}}{2} , \\ { }^{3} {Φ}_{Out , Loc , 1 , 2} = \frac{\begin{matrix}\text{?} ( {m}_{2 , 0} + i {m}_{3 , 0} ) + \text{?} \\ \text{?} ( {m}_{2 , 2} + i \text{?} ) + \text{?} ( \text{?} + i \text{?} )\end{matrix}}{2} , \\ { }^{3} {Φ}_{Out , Loc , 2 , 1} = \frac{\begin{matrix}\text{?} ( \text{?} - i \text{?} ) + \text{?} ( \text{?} - i \text{?} ) + \\ \text{?} ( {m}_{2 , 2} - i \text{?} ) + \text{?} ( \text{?} - i \text{?} )\end{matrix}}{2} , \\ { }^{3} {Φ}_{Out , Loc , 2 , 2} = \frac{\begin{matrix}\text{?} ( {m}_{0 , 0} - {m}_{1 , 0} ) + \text{?} ( {m}_{0 , 1} - {m}_{1 , 1} ) + \\ \text{?} ( {m}_{0 , 2} - {m}_{1 , 2} ) + \text{?} ( \text{?} - \text{?} )\end{matrix}}{2} , \\ \text{?} \text{indicates text missing or illegible when filed} \qquad ( 1.5 .3 )$$

and each local coordinate basis vectors form right-handed local coordinates, i.e., \hat{x}ᵢ⊥\hat{k}ᵢ and ŷᵢ=\hat{k}ᵢ×\hat{x}ᵢ where i=In, Out.

Using the inverse of Eq. (1.4.12) ³Φ_{In.Loc} can be written as a function of φ_{In,i,j}'s in global coordinates

³Φ_{In.Loc}=R_{In}⁻¹³Φ_{In}R_{In}, (1.5.4)

where R_{In}={\hat{x}_{In}, ŷ_{In}, \hat{k}_{In}}^{t}. Eq. (1.5.4) provides relationship between S_{In,i}'s and φ_{In,i,j}'s.

Similarly,

³Φ_{Out}=R_{Out}³Φ_{Out.Loc}R_{Out}⁻¹, (1.5.4)

where Rₒᵤₜ={\hat{x}_{Out}, ŷ_{Out}, \hat{k}_{Out}}^{t}.

Using Eq. (1.5.2) and (1.5.4), S_{In} can be written as a function of φ_{In,i,j}'s. Then using Eq. (1.5.3), S_{Out,i} can be written as a function of φ_{In,i,j} and m_{k,l} where i, j=x, y, z and k, l=0, 1, 2, 3. Then S_{Out} can be written as ³φ_{Out} by using Eq. (1.5.5) i.e., ³φ_{Out} can be written as a function of φ_{In,i,j} and m_{k,l}.

Again, the components of the tensor t_{i,j,k,l} are the coefficients of φ_{In,k,l} for φ_{Out,i,j}.

### 1.6.2 Polarization Ray Tracing Tensor Calculations

In this section, the example in Section 1.5.3 is revisited; the incident and exiting propagation vectors and a Mueller matrix, which is defined in the incident and exiting local coordinates are the given parameters,

$${\hat{k}}_{In} = \{ 0 , 0 , 1 \} , {\hat{k}}_{Out} = \{ - \frac{1}{2} , 0 , \frac{\sqrt{3}}{2} \} , {R}_{In} = ( \begin{matrix}1 & 0 & 0 \\ 0 & 1 & 0 \\ 0 & 0 & 1\end{matrix} ) , \\ {R}_{Out} = ( \begin{matrix}\frac{\sqrt{3}}{2} & 0 & - \frac{1}{2} \\ 0 & 1 & 0 \\ \frac{1}{2} & 0 & \frac{\sqrt{3}}{2}\end{matrix} ) , \\ M = ( \begin{matrix}0.886 & - 0.094 & 0 & 0 \\ - 0.094 & 0.886 & 0 & 0 \\ 0 & 0 & - 0.438 & - 0.764 \\ 0 & 0 & 0.764 & - 0.438\end{matrix} ) . \qquad ( 1.5 .6 )$$

Using Eq. (1.5.4)

$${Φ}_{In , Loc} = ( \begin{matrix}\frac{\text{?} + \text{?}}{2} & \frac{\text{?} + i \text{?}}{2} & 0 \\ \frac{\text{?} - i \text{?}}{2} & \frac{\text{?} - \text{?}}{2} & 0 \\ 0 & 0 & 0\end{matrix} ) = ( \begin{matrix}{φ}_{In , xx} & {φ}_{In , xy} & 0 \\ {φ}_{In , yx} & {φ}_{In , yy} & 0 \\ 0 & 0 & 0\end{matrix} ) . \\ \text{?} \text{indicates text missing or illegible when filed} \qquad ( 1.5 .7 )$$

### Thus,

$${S}_{In} = ( \begin{matrix}{S}_{In , 0} \\ {S}_{In , 1} \\ {S}_{In , 2} \\ {S}_{In , 3}\end{matrix} ) = ( \begin{matrix}{φ}_{In , xx} + {φ}_{In , yy} \\ {φ}_{In , xx} - {φ}_{In , yy} \\ {φ}_{In , xy} + {φ}_{In , yx} \\ i ( {φ}_{In , yx} - {φ}_{In , xy} )\end{matrix} ) . \qquad ( 1.5 .8 )$$

From the Mueller matrix and Eq. (1.5.8)

$$\begin{matrix} {S}_{Out} = ( \begin{matrix}0.886 ( {φ}_{In , xx} + {φ}_{In , yy} ) - 0.094 ( {φ}_{In , xx} - {φ}_{In , yy} ) \\ 0.886 ( {φ}_{In , xx} - {φ}_{In , yy} ) - 0.094 ( {φ}_{In , xx} + {φ}_{In , yy} ) \\ - 0.438 ( {φ}_{In , xy} + {φ}_{In , yx} ) + 0.764 i ( {φ}_{In , xy} - {φ}_{In , yx} ) \\ 0.438 i ( {φ}_{In , xy} - {φ}_{In , yx} ) + 0.764 ( {φ}_{In , xy} + {φ}_{In , yx} )\end{matrix} ) , \\ and & ( 1.5 .9 ) \\ \begin{matrix}{ }^{3} {Φ}_{Out , Loc} = ( \begin{matrix}\frac{\text{?} + \text{?}}{2} & \frac{\text{?} + i \text{?}}{2} & 0 \\ \frac{\text{?} - i \text{?}}{2} & \frac{\text{?} - \text{?}}{2} & 0 \\ 0 & 0 & 0\end{matrix} ) \\ = ( \begin{matrix}0.791 {φ}_{In , xx} & ( - 0.438 + 0.764 i ) {φ}_{In , xy} & 0 \\ ( - 0.438 - 0.764 i ) {φ}_{In , yx} & 0.980 {φ}_{In , yy} & 0 \\ 0 & 0 & 0\end{matrix} )\end{matrix} \\ \text{?} \text{indicates text missing or illegible when filed} & ( 1.5 .10 )\end{matrix}$$

Using Eq. (1.5.5), the exiting coherence matrix in global coordinates is

$${}_{}^{3}{Φ}{}_{Out}^{} = ( \begin{matrix}0.593 {φ}_{In , xx} & ( - 0.380 + 0.661 i ) {φ}_{In , xy} & 0.343 {φ}_{In , xx} \\ ( - 0.380 - 0.661 i ) {φ}_{In , yx} & 0.980 {φ}_{In , yy} & ( - 0.219 - 0.382 i ) {φ}_{In , yx} \\ 0.343 {φ}_{In , xx} & ( - 0.219 + 0.382 i ) {φ}_{In , xy} & 0.198 {φ}_{In , xx}\end{matrix} ) , \qquad ( 1.5 .11 )$$

and the polarization ray tracing tensor is

$$T = ( \begin{matrix}( \begin{matrix}0.593 & 0 & 0 \\ 0 & 0 & 0 \\ 0 & 0 & 0\end{matrix} ) & ( \begin{matrix}0 & - 0.380 + 0.661 i & 0 \\ 0 & 0 & 0 \\ 0 & 0 & 0\end{matrix} ) & ( \begin{matrix}0.343 & 0 & 0 \\ 0 & 0 & 0 \\ 0 & 0 & 0\end{matrix} ) \\ ( \begin{matrix}0 & 0 & 0 \\ - 0.380 - 0.661 i & 0 & 0 \\ 0 & 0 & 0\end{matrix} ) & ( \begin{matrix}0 & 0 & 0 \\ 0 & 0.980 & 0 \\ 0 & 0 & 0\end{matrix} ) & ( \begin{matrix}0 & 0 & 0 \\ - 0.219 - 0.382 i & 0 & 0 \\ 0 & 0 & 0\end{matrix} ) \\ ( \begin{matrix}0.343 & 0 & 0 \\ 0 & 0 & 0 \\ 0 & 0 & 0\end{matrix} ) & ( \begin{matrix}0 & - 0.219 + 0.382 i & 0 \\ 0 & 0 & 0 \\ 0 & 0 & 0\end{matrix} ) & ( \begin{matrix}0.198 & 0 & 0 \\ 0 & 0 & 0 \\ 0 & 0 & 0\end{matrix} )\end{matrix} ) , \qquad ( 1.5 .12 )$$

which are the same as Eq. (1.4.30) and (1.4.31).

### 1.7 Polarization Ray Tracing Tensors and Combinations of Tensors

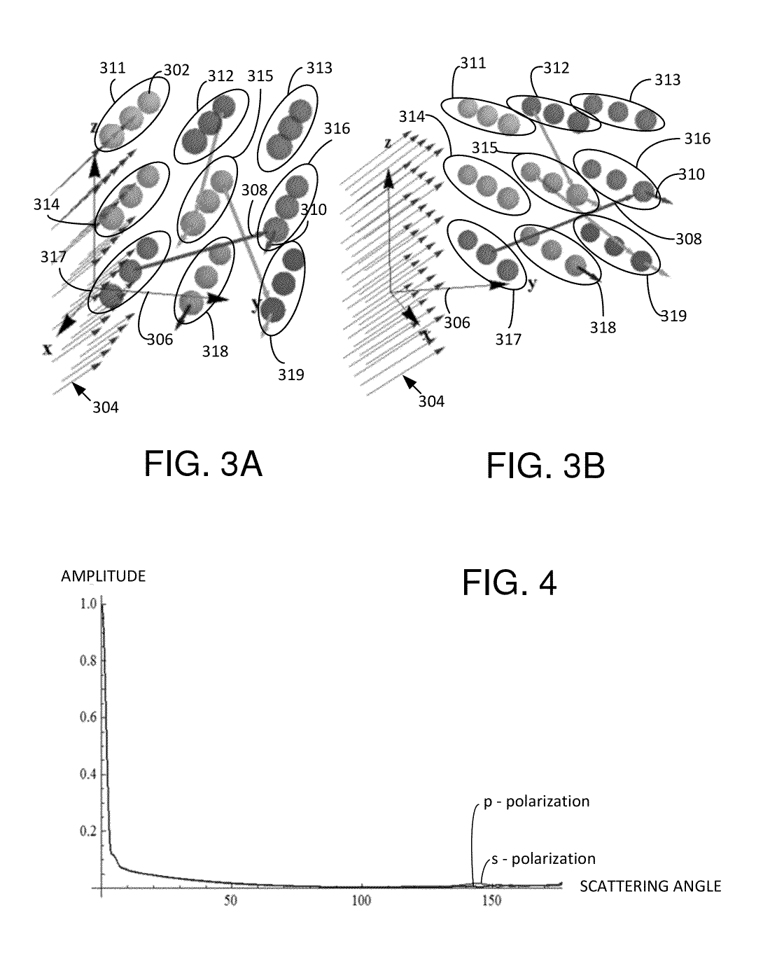

An example of the incoherent scattering of light from a scattering volume is now provided to further explain the methods. Most clouds have various particles with different scattering properties, sizes, refractive indices, etc. In this section, a simple and tractable but also realistic cloud model is set up in order to understand some aspects of the complex phenomena of cloud polarization. The polarization ray tracing tensor calculus is implemented to ray trace through a simplified cloud model and the PRTTs are incoherently added for the data analysis. The scattering particles are spherical water droplets such as droplet 302 shown in FIGS. 3A-3B with refractive index of 1.3325704+1.67*10⁻⁸ in air with refractive index of 1.0002857; this is the simplified model of cubical cloud. Mie scattering is assumed and the s and p polarization reflection coefficients at various scattering angles are calculated. The black body radiation from the sun with the spectrum between 380 nm to 700 nm is assumed for the light source. The size of the water droplets has a normal distribution with mean of 5 μm and 5% standard deviation. Scattered light intensity is calculated by averaging over 30 different wavelengths within the spectrum and 50 different water droplet sizes from the normal distribution as the scattering angle changes. The water droplet sizes for this cloud example are normally distributed with a mean of 5 μm and are listed in the table below:

| # | Size (μm) |
|---|---|
| 1 | 5.00635 |
| 2 | 5.01906 |
| 3 | 5.03182 |
| 4 | 5.04466 |
| 5 | 5.05761 |
| 6 | 5.07072 |
| 7 | 5.08402 |
| 8 | 5.09756 |
| 9 | 5.11138 |
| 10 | 5.12555 |
| 11 | 5.14012 |
| 12 | 5.15516 |
| 13 | 5.17078 |
| 14 | 5.18707 |
| 15 | 5.20418 |
| 16 | 5.22228 |
| 17 | 5.24159 |
| 18 | 5.26242 |
| 19 | 5.2852 |
| 20 | 5.31055 |
| 21 | 5.33948 |
| 22 | 5.37366 |
| 23 | 5.41647 |
| 24 | 5.47621 |
| 25 | 5.58902 |
| 26 | 4.99365 |
| 27 | 4.98094 |
| 28 | 4.96818 |
| 29 | 4.95534 |
| 30 | 4.94239 |
| 31 | 4.92928 |
| 32 | 4.91598 |
| 33 | 4.90244 |
| 34 | 4.88862 |
| 35 | 4.87445 |
| 36 | 4.85988 |
| 37 | 4.84484 |
| 38 | 4.32922 |
| 39 | 4.81293 |
| 40 | 4.79582 |
| 41 | 4.77772 |
| 42 | 4.75841 |
| 43 | 4.73758 |
| 44 | 4.7148 |
| 45 | 4.68945 |
| 46 | 4.66052 |
| 47 | 4.62634 |
| 48 | 4.58353 |
| 49 | 4.52379 |
| 50 | 4.41098 |

The geometry of the volume scattering calculation is shown in FIGS. 3A-3B in two different views. Arrows 304 indicate the incident beam of light and various other arrows indicate sample single and double scattered ray paths from the incident light to the detector.

Twenty seven scattering volumes of water droplets are positioned in a cubic grid. The position vectors {x,y,z} are x=1, 2, 3, y=1, 2, 3, and z=1, 2, 3. Each water droplet is numbered from 1 to 27 starting from {1,1,1} to {3,3,3}. A collimated beam of light (for example from the sun) is incident on the scattering volume along \hat{k}_{In}. A polarimeter views the volume along the x-axis (\hat{k}_{Out}) which is chosen to allow easy summation of many different ray paths,

\hat{k}_{In}={1,1,1}/\sqrt{3}, \hat{k}_{Out}={1,0,0}. (1.6.1)

No absorption or extinction is assumed along the ray paths. The majority of the ray paths experience two scattering events and the remainder experience a single scattering event. Ray paths with single scattering event are called path₁ and ray paths with two scattering events are called path₂. There are 27 path₁ and 702 path₂ ray paths. By fixing the viewing angle of the polarimeter along \hat{k}_{Out}, only the scattered light along \hat{k}_{Out} after the first scattering for path₁, and after the second scattering for path₂, get detected by the polarimeter.

A polarization ray tracing tensor is calculated for each scattering event and for each ray path using the reflection coefficients calculated from the Mie scattering function at a given scattering angle as shown in FIG. 4. Each tensor T_{q,r} has subscripts q and r where r stands for the first water droplet and q stands for the second water droplet from which each ray path scatters; q, r=1, 2, . . . , 27. When q=r, T_{q,q} represents the single scattering tensor from the q^{th} water droplet. Scattering angles are in degrees and the s polarization reflection coefficients are plotted in red whereas the p polarization reflection coefficients are plotted in blue. The scattering angle is the angle between the incident and scattered light propagation vectors. If the scattering angle is less than 90°, the interaction is forward scattering since the propagation vectors are along the same direction and if the scattering angle is greater than 90°, the interaction is backward scattering.

Then tensors representing ray paths that scatter from the q^{th} water droplet toward the polarimeter are added

T_{Sum,q}=Σᵣ₌₁²⁷T_{q,r}. (1.6.2)

wherein q=1, 2, 3, . . . , 27. Each T_{Sum,q} now contains depolarization effects from scattering.

The last step is adding the tensors from the same colored water droplets (along the x-axis) and calculating T_{pixel,n},

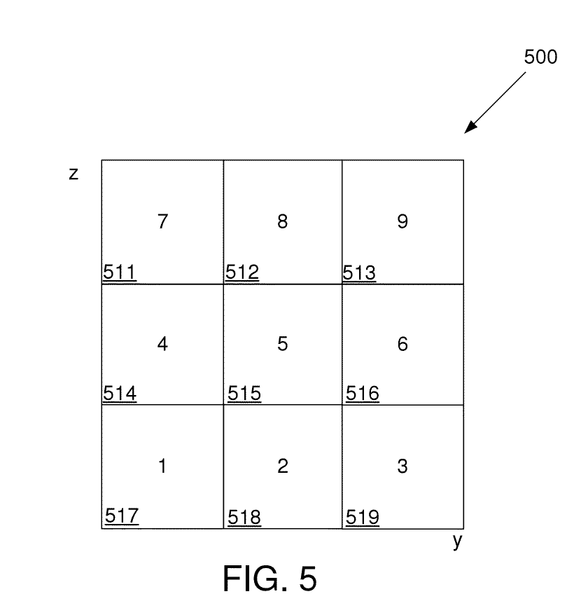

T_{pixel,n}=Σ_{q=3n-2}³ⁿT_{Sum,q} (1.6.3)

where n=1, 2, 3, . . . , 9. This step creates a nine-by-nine grid of polarization ray tracing tensors as shown in FIG. 5. Detector grid elements 511, 512, . . . , 519 in FIG. 5 correspond to scattering from respective water droplet groups 311, 312, . . . , 319 shown in FIG. 3.

The polarization ray tracing tensors corresponding to detector pixels are

$${T}_{1} \vert ( \begin{matrix}( \begin{matrix}27 , & 27 , & 27 , \\ 27 , & 27 , & 27 , \\ 27 , & 27 , & 27 ,\end{matrix} ) & ( \begin{matrix}0.0301 & - 0.036 & 0.4079 \\ 0.0301 & - 0.038 & 0.0079 \\ 0.0301 & - 0.036 & 0.0079\end{matrix} ) & ( \begin{matrix}- 0.0311 & - 0.0066 & 0.0397 \\ - 0.0311 & - 0.00 \text{?} 6 & 0.0397 \\ - 0.0311 & - 0.0066 & 0.0397\end{matrix} ) \\ ( \begin{matrix}0.0301 & 0.0301 & 0.0301 \\ - 0.03 \text{?} & - 0.03 \text{?} & - 0.03 \text{?} \\ 0.0079 & 0.0079 & 0.0079\end{matrix} ) & ( \begin{matrix}0.0005 & - 0.0006 & 0.0001 \\ - 0.0006 & 0.000 \text{?} & - 0.0002 \\ 0.0001 & - 0.0002 & 0\end{matrix} ) & ( \begin{matrix}- 0.0005 & - 0.0001 & 0.0006 \\ 0.0006 & 0.0002 & - 0.000 \text{?} \\ 0.0001 & 0 & 0.0002\end{matrix} ) \\ ( \begin{matrix}- 0.0311 & - 0.0311 & - 0.0311 \\ - 0.0066 & - 0.00 \text{?} 6 & - 0.00 \text{?} 6 \\ 0.0397 & 0.0397 & 0.0397\end{matrix} ) & ( \begin{matrix}- 0.0005 & 0.000 \text{?} & - 0.0001 \\ - 0.0001 & 0.0002 & 0 \\ 0.000 \text{?} & - 0.000 \text{?} & 0.0002\end{matrix} ) & ( \begin{matrix}0.0005 & 0.0001 & - 0.0006 \\ 0.0001 & 0 & - 0.0002 \\ - 0.0006 & - 0.0002 & 0.0000\end{matrix} )\end{matrix} ) \\ {T}_{2} \vert ( \begin{matrix}( \begin{matrix}27 , & 27 , & 27 , \\ 27 , & 27 , & 27 , \\ 27 , & 27 , & 27 ,\end{matrix} ) & ( \begin{matrix}0.0286 & - 0.0371 & 0.0083 \\ 0.0283 & - 0.0371 & 0.0083 \\ 0.0286 & - 0.0371 & 0.0083\end{matrix} ) & ( \begin{matrix}- 0.0314 & 0.009 \text{?} & 0.0409 \\ - 0.0314 & - 0.009 \text{?} & 0.0409 \\ - 0.0314 & - 0.0095 & 0.0409\end{matrix} ) \\ ( \begin{matrix}0.0288 & 0.0288 & 0.0288 \\ - 0.0371 & - 0.0371 & - 0.0371 \\ 0.0083 & 0.0083 & 0.0083\end{matrix} ) & ( \begin{matrix}0.0005 & - 0.0006 & 0.0001 \\ - 0.0006 & 0.0008 & - 0.000 \\ 0.0001 & - 0.0002 & 0\end{matrix} ) & ( \begin{matrix}- 0.0005 & - 0.0001 & 0.0006 \\ 0.0006 & 0.0002 & - 0.0008 \\ - 0.0001 & 0 & 0.0002\end{matrix} ) \\ ( \begin{matrix}- 0.0314 & - 0.0314 & - 0.0314 \\ - 0.0095 & - 0.0095 & - 0.0095 \\ 0.0409 & 0.0409 & 0.0409\end{matrix} ) & ( \begin{matrix}- 0.0005 & 0.0006 & - 0.0001 \\ - 0.0001 & 0.0002 & 0 \\ 0.0006 & - 0.0008 & 0.0002\end{matrix} ) & ( \begin{matrix}0.0005 & 0.0001 & - 0.0006 \\ 0.0001 & 0 & - 0.0002 \\ - 0.0006 & - 0.0002 & 0.0008\end{matrix} )\end{matrix} ) \\ {T}_{3} \vert ( \begin{matrix}( \begin{matrix}27 , & 27 , & 27 , \\ 27 , & 27 , & 27 , \\ 27 , & 27 , & 27 ,\end{matrix} ) & ( \begin{matrix}0.0281 & - 0.0367 & 0.0086 \\ 0.0281 & - 0.0367 & 0.0086 \\ 0.0281 & - 0.0367 & 0.0086\end{matrix} ) & ( \begin{matrix}- 0.0315 & - 0.01 & 0.0415 \\ - 0.0315 & - 0.01 & 0.0415 \\ - 0.0315 & - 0.01 & 0.0415\end{matrix} ) \\ ( \begin{matrix}0.0281 & 0.0281 & 0.0281 \\ - 0.0367 & - 0.0367 & - 0.0367 \\ 0.0086 & 0.0086 & 0.0086\end{matrix} ) & ( \begin{matrix}0.0005 & - 0.0006 & 0.0001 \\ - 0.0006 & 0.0008 & - 0.0002 \\ 0.0001 & - 0.0002 & 0\end{matrix} ) & ( \begin{matrix}- 0.0005 & - 0.0001 & 0.0006 \\ 0.0006 & 0.0002 & - 0.0008 \\ - 0.0001 & 0 & 0.0002\end{matrix} ) \\ ( \begin{matrix}- 0.0315 & - 0.0315 & - 0.0315 \\ - 0.01 & - 0.01 & - 0.01 \\ 0.0415 & 0.0415 & 0.0415\end{matrix} ) & ( \begin{matrix}- 0.0005 & 0.0006 & - 0.0001 \\ - 0.0001 & 0.0002 & 0 \\ 0.0006 & - 0.0008 & 0.0002\end{matrix} ) & ( \begin{matrix}0.0005 & 0.0001 & - 0.0006 \\ 0.0001 & 0 & - 0.0002 \\ - 0.0006 & - 0.0002 & 0.0008\end{matrix} )\end{matrix} ) \\ {T}_{4} \vert ( \begin{matrix}( \begin{matrix}27 , & 27 , & 27 , \\ 27 , & 27 , & 27 , \\ 27 , & 27 , & 27 ,\end{matrix} ) & ( \begin{matrix}0.0299 & - 0.0368 & 0.007 \\ 0.0299 & - 0.0368 & 0.007 \\ 0.0299 & - 0.0368 & 0.007\end{matrix} ) & ( \begin{matrix}- 0.0325 & - 0.0081 & 0.0406 \\ - 0.0325 & - 0.0081 & 0.0406 \\ - 0.0325 & - 0.0081 & 0.0406\end{matrix} ) \\ ( \begin{matrix}0.0299 & 0.0299 & 0.0299 \\ - 0.0368 & - 0.0368 & - 0.0368 \\ 0.007 & 0.007 & 0.007\end{matrix} ) & ( \begin{matrix}0.0005 & - 0.0006 & 0.0001 \\ - 0.0006 & 0.0008 & - 0.0002 \\ 0.0001 & - 0.0002 & 0\end{matrix} ) & ( \begin{matrix}- 0.0005 & - 0.0001 & 0.0006 \\ 0.0006 & 0.0002 & - 0.0008 \\ - 0.0001 & 0 & 0.0002\end{matrix} ) \\ ( \begin{matrix}- 0.0325 & - 0.0325 & - 0.0325 \\ - 0.0081 & - 0.0081 & - 0.0081 \\ 0.0406 & 0.0406 & 0.0406\end{matrix} ) & ( \begin{matrix}- 0.0005 & 0.0006 & - 0.0001 \\ - 0.0001 & 0.0002 & 0 \\ 0.0006 & - 0.0008 & 0.0002\end{matrix} ) & ( \begin{matrix}0.0005 & 0.0001 & - 0.0006 \\ 0.0001 & 0 & - 0.0002 \\ - 0.0006 & - 0.0002 & 0.0008\end{matrix} )\end{matrix} ) \\ {T}_{5} \vert ( \begin{matrix}( \begin{matrix}27 , & 27 , & 27 , \\ 27 , & 27 , & 27 , \\ 27 , & 27 , & 27 ,\end{matrix} ) & ( \begin{matrix}0.0409 & - 0.0453 & 0.0044 \\ 0.0409 & - 0.0453 & 0.0044 \\ 0.0409 & - 0.0453 & 0.0044\end{matrix} ) & ( \begin{matrix}- 0.0361 & - 0.0195 & 0.0555 \\ - 0.0361 & - 0.0195 & 0.0555 \\ - 0.0361 & - 0.0195 & 0.0555\end{matrix} ) \\ ( \begin{matrix}0.0409 & 0.0409 & 0.0409 \\ - 0.0453 & - 0.0453 & - 0.0453 \\ 0.0044 & 0.0044 & 0.0044\end{matrix} ) & ( \begin{matrix}0.0007 & - 0.0008 & 0.0001 \\ - 0.0008 & 0.0009 & - 0.0001 \\ 0.0001 & - 0.0001 & 0\end{matrix} ) & ( \begin{matrix}- 0.0005 & - 0.0003 & 0.0008 \\ 0.0006 & 0.0003 & - 0.001 \\ - 0.0001 & 0 & 0.0001\end{matrix} ) \\ ( \begin{matrix}- 0.0361 & - 0.0361 & - 0.0361 \\ - 0.0195 & - 0.0195 & - 0.0195 \\ 0.0555 & 0.0555 & 0.0555\end{matrix} ) & ( \begin{matrix}- 0.0005 & 0.0006 & - 0.0001 \\ - 0.0053 & 0.0003 & 0 \\ 0.0008 & - 0.001 & 0.0001\end{matrix} ) & ( \begin{matrix}0.0005 & 0.0002 & - 0.0007 \\ 0.0002 & 0.0002 & - 0.0004 \\ - 0.0007 & - 0.0004 & 0.001\end{matrix} )\end{matrix} ) \\ {T}_{6} \vert ( \begin{matrix}( \begin{matrix}27 , & 27 , & 27 , \\ 27 , & 27 , & 27 , \\ 27 , & 27 , & 27 ,\end{matrix} ) & ( \begin{matrix}0.0394 & - 0.0442 & 0.0048 \\ 0.0394 & - 0.0442 & 0.0048 \\ 0.0394 & - 0.0442 & 0.0048\end{matrix} ) & ( \begin{matrix}- 0.0366 & - 0.0204 & 0.057 \\ - 0.0366 & - 0.0204 & 0.057 \\ - 0.0366 & - 0.0204 & 0.057\end{matrix} ) \\ ( \begin{matrix}0.0394 & 0.0394 & 0.0394 \\ - 0.0442 & - 0.0442 & - 0.0442 \\ 0.0048 & 0.0048 & 0.0048\end{matrix} ) & ( \begin{matrix}0.0007 & - 0.0008 & 0.0001 \\ - 0.0008 & 0.0009 & - 0.0001 \\ 0.0001 & - 0.0001 & 0\end{matrix} ) & ( \begin{matrix}- 0.0005 & - 0.0003 & 0.0008 \\ 0.0006 & 0.0003 & - 0.001 \\ - 0.0001 & 0 & 0.0001\end{matrix} ) \\ ( \begin{matrix}- 0.0366 & - 0.0366 & - 0.0366 \\ - 0.0204 & - 0.0204 & - 0.0204 \\ 0.057 & 0.057 & 0.057\end{matrix} ) & ( \begin{matrix}- 0.0005 & 0.0006 & - 0.0001 \\ - 0.0003 & 0.0003 & 0 \\ 0.0008 & - 0.001 & 0.0001\end{matrix} ) & ( \begin{matrix}0.0005 & 0.0002 & - 0.0007 \\ 0.0002 & 0.0002 & - 0.0004 \\ - 0.0007 & - 0.0004 & 0.001\end{matrix} )\end{matrix} ) \\ {T}_{7} \vert ( \begin{matrix}( \begin{matrix}27 , & 27 , & 27 , \\ 27 , & 27 , & 27 , \\ 27 , & 27 , & 27 ,\end{matrix} ) & ( \begin{matrix}0.0299 & - 0.0362 & 0.0063 \\ 0.0299 & - 0.0362 & 0.0063 \\ 0.0299 & - 0.0362 & 0.0063\end{matrix} ) & ( \begin{matrix}- 0.0333 & - 0.0077 & 0.041 \\ - 0.033 & - 0.0077 & 0.041 \\ - 0.0333 & - 0.0077 & 0.041\end{matrix} ) \\ ( \begin{matrix}0.0299 & 0.0299 & 0.0299 \\ - 0.0362 & - 0.0362 & - 0.0362 \\ 0.0063 & 0.0063 & 0.0063\end{matrix} ) & ( \begin{matrix}0.0005 & - 0.0006 & 0.0001 \\ - 0.0006 & 0.0008 & - 0.0002 \\ 0.0001 & - 0.0002 & 0\end{matrix} ) & ( \begin{matrix}- 0.0005 & - 0.0001 & 0.0006 \\ 0.0006 & 0.0002 & - 0.0008 \\ - 0.0001 & 0 & 0.0002\end{matrix} ) \\ ( \begin{matrix}- 0.0333 & - 0.0333 & - 0.0333 \\ - 0.0077 & - 0.0077 & - 0.0077 \\ 0.041 & 0.041 & 0.041\end{matrix} ) & ( \begin{matrix}- 0.0005 & 0.0006 & - 0.0001 \\ - 0.0001 & 0.0002 & 0 \\ 0.0006 & - 0.0008 & 0.0002\end{matrix} ) & ( \begin{matrix}0.0005 & 0.0001 & - 0.0006 \\ 0.0001 & 0 & - 0.0002 \\ - 0.0006 & - 0.0002 & 0.0008\end{matrix} )\end{matrix} ) \\ {T}_{8} \vert ( \begin{matrix}( \begin{matrix}27 , & 27 , & 27 , \\ 27 , & 27 , & 27 , \\ 27 , & 27 , & 27 ,\end{matrix} ) & ( \begin{matrix}0.0406 & - 0.0439 & 0.0033 \\ 0.0406 & - 0.0439 & 0.0033 \\ 0.0406 & - 0.0439 & 0.0033\end{matrix} ) & ( \begin{matrix}- 0.0377 & - 0.019 & 0.0567 \\ - 0.0377 & - 0.019 & 0.0567 \\ - 0.0377 & - 0.019 & 0.0567\end{matrix} ) \\ ( \begin{matrix}0.0406 & 0.0406 & 0.0406 \\ - 0.0439 & - 0.0439 & - 0.0439 \\ 0.0033 & 0.0033 & 0.0033\end{matrix} ) & ( \begin{matrix}0.0007 & - 0.0008 & 0.0001 \\ - 0.0008 & 0.0009 & - 0.0001 \\ 0.0001 & - 0.0001 & 0\end{matrix} ) & ( \begin{matrix}- 0.0005 & - 0.0003 & 0.0008 \\ 0.0006 & 0.0003 & - 0.001 \\ - 0.001 & 0 & 0.0001\end{matrix} ) \\ ( \begin{matrix}- 0.0377 & - 0.0377 & - 0.0377 \\ - 0.019 & - 0.019 & - 0.019 \\ 0.0567 & 0.0567 & 0.0567\end{matrix} ) & ( \begin{matrix}- 0.0005 & 0.0006 & - 0.0001 \\ - 0.0003 & 0.0003 & 0 \\ 0.0005 & - 0.001 & 0.0001\end{matrix} ) & ( \begin{matrix}0.0005 & 0.0002 & - 0.0007 \\ 0.0002 & 0.0002 & - 0.0004 \\ - 0.0007 & - 0.0004 & 0.001\end{matrix} )\end{matrix} ) \\ {T}_{9} \vert ( \begin{matrix}( \begin{matrix}27 , & 27 , & 27 , \\ 27 , & 27 , & 27 , \\ 27 , & 27 , & 27 ,\end{matrix} ) & ( \begin{matrix}0.0452 & - 0.0475 & 0.0023 \\ 0.0452 & - 0.0475 & 0.0023 \\ 0.0452 & - 0.0475 & 0.0023\end{matrix} ) & ( \begin{matrix}- 0.0398 & - 0.0252 & 0.0649 \\ - 0.0398 & - 0.0252 & 0.0649 \\ - 0.0398 & - 0.0252 & 0.0649\end{matrix} ) \\ ( \begin{matrix}0.0452 & 0.0452 & 0.0452 \\ - 0.0475 & - 0.0475 & - 0.0475 \\ 0.0023 & 0.0023 & 0.0023\end{matrix} ) & ( \begin{matrix}0.0009 & - 0.0009 & 0 \\ - 0.0009 & 0.001 & - 0.0001 \\ 0 & - 0.0001 & 0.0001\end{matrix} ) & ( \begin{matrix}- 0.0005 & - 0.0004 & 0.001 \\ 0.0007 & 0.0004 & - 0.001 \\ - 0.0001 & 0 & 0.0001\end{matrix} ) \\ ( \begin{matrix}- 0.0398 & - 0.0398 & - 0.0398 \\ - 0.0252 & - 0.0252 & - 0.0252 \\ 0.0649 & 0.0649 & 0.0649\end{matrix} ) & ( \begin{matrix}- 0.0005 & 0.0007 & - 0.0001 \\ - 0.0004 & 0.0004 & 0 \\ 0.001 & - 0.001 & 0.0001\end{matrix} ) & ( \begin{matrix}0.0005 & 0.0002 & - 0.0007 \\ 0.0002 & 0.0003 & - 0.0005 \\ - 0.0007 & - 0.0005 & 0.0011\end{matrix} )\end{matrix} ) \\ \text{?} \text{indicates text missing or illegible when filed} \qquad ( 1.6 .4 )$$

For an electric field vector {Eₓ, E_{y}, E_{z}} with a coherence matrix

$$( \begin{matrix}{φ}_{xx} & {φ}_{xy} & {φ}_{xz} \\ {φ}_{yx} & {φ}_{yy} & {φ}_{yz} \\ {φ}_{zx} & {φ}_{zy} & {φ}_{zz}\end{matrix} ) ,$$

the exiting coherence matrix (³Φ_{Out,j}) after propagating through a volume of scatterers and detected at j^{th} pixel can be calculated from Eq. (1.4.2) and Tⱼ in Eq. (1.6.4). For example, ³Φ_{Out,s} is

³Φ_{Out,5,1,1}=27(φₓₓ+φ_{xy}+φ_{xz}+φ_{yx}+φ_{yy}+φ_{yz}+φ_{zx}+φ_{zy}+φ_{zz}),

³Φ_{Out,5,2,2}=0.0409(φₓₓ+φ_{yx}+φ_{zx})−0.0453(φ_{xy}+φ_{yy}+φ_{zy})+0.0044(φ_{xz}+φ_{yz}+φ_{zz}),

³Φ_{Out,5,1,3}=0.0361(φₓₓ+φ_{yx}+φ_{zx})−0.0195(φ_{xy}+φ_{yy}+φ_{zy})+0.0555(φ_{xz}+φ_{yz}+φ_{zz})

³Φ_{Out,5,2,1}=0.0409(φₓₓ+φ_{yx}+φ_{zx})−0.0453(φ_{xy}+φ_{yy}+φ_{zy})+0.0044(φ_{zx}+φ_{zy}+φ_{zz}),

³Φ_{Out,5,1,2}=0.001(7φₓₓ−8φ_{xy}+φ_{xz}−8φ_{yx}+9φ_{yy}−φ_{yz}+φ_{zx}−φ_{zy}),

³Φ_{Out,5,2,3}=0.001(5φₓₓ+3φ_{xy}−8φ_{xz}−6φ_{yx}−3φ_{yy}+φ_{yz}+φ_{zy}−φ_{zz}),

³Φ_{Out,5,3,1}=−0.0361(φₓₓ+φ_{xy}+φ_{xz})−0.0195(φ_{yx}+φ_{yy}+φ_{yz})+0.0555(φ_{zx}+φ_{zy}+φ_{zz})

³Φ_{Out,5,3,2}=0.001(5φₓₓ−6φ_{xy}+φ_{xz}+3φ_{yx}−3φ_{yy}−8φ_{zx}+φ_{zy}−φ_{zz})

³Φ_{Out,5,3,3}=0.001(5φₓₓ+2φ_{xy}−7φ_{xz}+2φ_{yx}+2φ_{yy}−4φ_{yz}−7φ_{zx}−4φ_{zy}+φ_{zz}) (1.6.5)

The coherence matrix of unpolarized light is

$${}_{}^{3}{φ}{}_{Unpol}^{} = ( \begin{matrix}0.333 & - 0.167 & - 0.167 \\ - 0.167 & 0.333 & - 0.167 \\ - 0.167 & - 0.167 & 0.333\end{matrix} ) \qquad ( 1.6 .6 )$$

and the ³DOP=0.5. This light is equivalent to a 2D Stokes vector {1, 0, 0, 0} with the propagation vector \hat{k}_{In}. The exiting coherence matrix at each pixel on the detector is calculated from tensors in Eq. (1.6.4)

$${}_{}^{3}{Φ}{}_{Out , 1}^{} = ( \begin{matrix}0 & 0 & 0 \\ 0 & 0.0006304778 & - 0.0000737567 \\ 0 & - 0.0000737567 & 0.0006304811\end{matrix} ) , \\ {}_{}^{3}{Φ}{}_{Out , 2}^{} = ( \begin{matrix}0 & 0 & 0 \\ 0 & 0.0006312711 & - 0.0000737245 \\ 0 & - 0.0000737245 & 0.0006312863\end{matrix} ) , \\ {}_{}^{3}{Φ}{}_{Out , 3}^{} = ( \begin{matrix}0 & 0 & 0 \\ 0 & 0.0006314806 & - 0.0000737221 \\ 0 & - 0.0000737221 & 0.000631499\end{matrix} ) , \\ {}_{}^{3}{Φ}{}_{Out , 4}^{} = ( \begin{matrix}0 & 0 & 0 \\ 0 & 0.000631283 & - 0.0000737245 \\ 0 & - 0.0000737245 & 0.0006312744\end{matrix} ) , \\ {}_{}^{3}{Φ}{}_{Out , 5}^{} = ( \begin{matrix}0 & 0 & 0 \\ 0 & 0.0008430425 & - 0.0000490713 \\ 0 & - 0.0000490713 & 0.0008430477\end{matrix} ) , \\ {}_{}^{3}{Φ}{}_{Out , 6}^{} = ( \begin{matrix}0 & 0 & 0 \\ 0 & 0.0008438861 & - 0.0000490217 \\ 0 & - 0.0000490217 & 0.0008438166\end{matrix} ) , \\ {}_{}^{3}{Φ}{}_{Out , 7}^{} = ( \begin{matrix}0 & 0 & 0 \\ 0 & 0.0006314957 & - 0.0000737221 \\ 0 & - 0.0000737221 & 0.0006314838\end{matrix} ) , \\ {}_{}^{3}{Φ}{}_{Out , 8}^{} = ( \begin{matrix}0 & 0 & 0 \\ 0 & 0.0008438114 & - 0.0000490217 \\ 0 & - 0.0000490217 & 0.0008438912\end{matrix} ) , \\ {}_{}^{3}{Φ}{}_{Out , 9}^{} = ( \begin{matrix}0 & 0 & 0 \\ 0 & 0.000949833 & - 0.0000366665 \\ 0 & - 0.0000366665 & 0.0009498392\end{matrix} ) . \qquad ( 1.6 .7 )$$

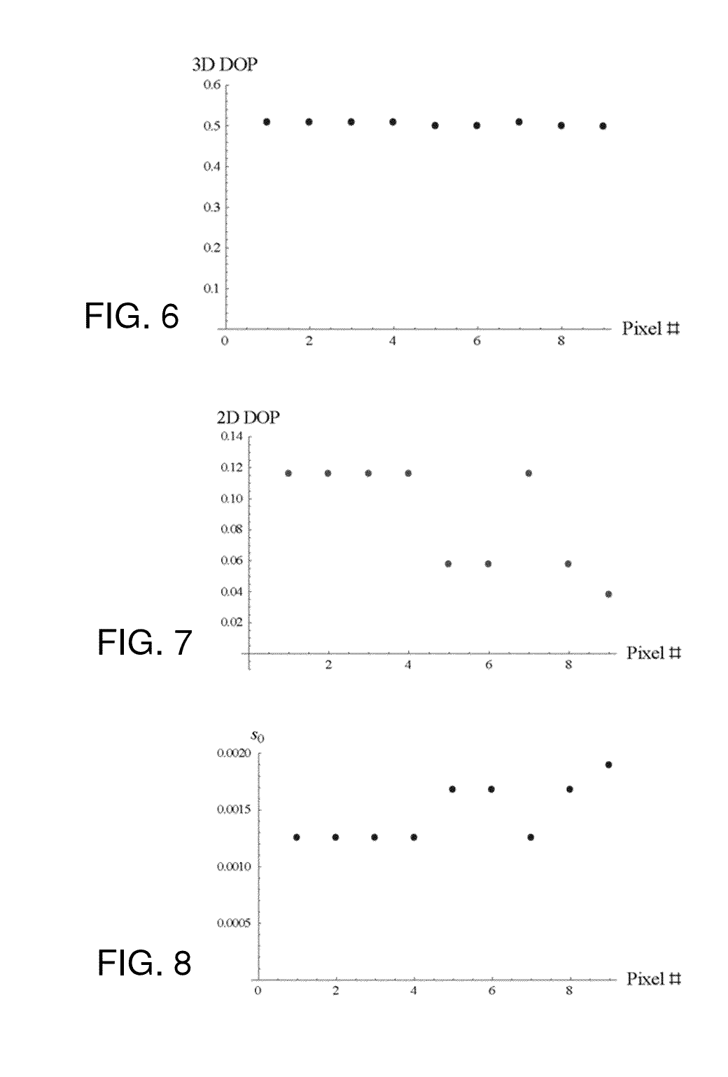

Note that none of the exiting coherence matrices have x-electric field components since the exiting propagation vector is along the x-axis. The 3D degree of polarization of each exiting coherence matrix indicates that the exiting light is mostly unpolarized. FIG. 6 shows ³DOP for each pixel number 1, 2, . . . , 9.

Each exiting coherence matrix can be reduced to 2D Stokes vectors in its local coordinates on the detector plane,

$${S}_{Out , 1} = ( \begin{matrix}0.0012609589 \\ 3.3 \times {10}^{- 9} \\ 0.0001475134 \\ 0\end{matrix} ) , {S}_{Out , 2} = ( \begin{matrix}0.0012625574 \\ 1.52 \times {10}^{- 8} \\ 0.000147449 \\ 0\end{matrix} ) , \\ {S}_{Out , 3} = ( \begin{matrix}0.0012629796 \\ 1.84 \times {10}^{- 8} \\ 0.0001474442 \\ 0\end{matrix} ) , {S}_{Out , 4} = ( \begin{matrix}0.0012625574 \\ - 8.6 \times {10}^{- 9} \\ 0.000147449 \\ 0\end{matrix} ) , \\ {S}_{Out , 5} = ( \begin{matrix}0.0016860902 \\ 5.2 \times {10}^{- 9} \\ 0.0000981426 \\ 0\end{matrix} ) , {S}_{Out , 6} = ( \begin{matrix}0.0016877027 \\ - 6.95 \times {10}^{- 8} \\ 0.0000980434 \\ 0\end{matrix} ) , \\ {S}_{Out , 7} = ( \begin{matrix}0.0012629795 \\ - 1.19 \times {10}^{- 8} \\ 0.0001474442 \\ 0\end{matrix} ) , {S}_{Out , 8} = ( \begin{matrix}0.0016877026 \\ 7.98 \times {10}^{- 8} \\ 0.0000980434 \\ 0\end{matrix} ) , \\ {S}_{Out , 9} = ( \begin{matrix}0.0018996722 \\ 6.2 \times {10}^{- 9} \\ 0.000073333 \\ 0\end{matrix} ) , \qquad ( 1.6 .8 )$$

where the local coordinates are

$${\hat{x}}_{Loc} = ( \begin{matrix}0 \\ 0 \\ - 1\end{matrix} ) , \\ {\hat{y}}_{Loc} = ( \begin{matrix}0 \\ 1 \\ 0\end{matrix} ) , \\ {\hat{k}}_{Out} = ( \begin{matrix}1 \\ 0 \\ 0\end{matrix} ) . \qquad ( 1.6 .9 )$$

2D degree of polarization can be calculated for each 2D Stokes vector and is plotted in FIG. 7. Again, 2D degree of polarization indicates that the exiting light is mostly unpolarized.

Both 2D and 3D degree of polarization of pixels 1, 2, 3, 4, and 7 are the same values. The pixels 1, 2, and 3 are aligned with the bottom row (the smallest z-value) of the water droplets and the pixels 3, 4, and 7 are aligned with the left most column (the smallest y-values) of the water droplets, which are the closest water droplets from the collimated incident plane wave. Therefore, most of the path₂ exiting from the water droplets that are aligned with pixels 1, 2, 3, 4, and 7 come from the backward scattering (scattering angles >90°) whereas other water droplets have more forward scatterings than backward scatterings. All the single scattering paths path₁ are equally distributed among nine pixels. As shown in FIG. 4, backward scattering reflection coefficients are smaller than the forward scattering reflection coefficients. Therefore, S₀ components of the 2D Stokes vectors in Eq. (1.6.8) are smaller for the pixels 1, 2, 3, 4, and 7 than other pixels as shown in FIG. 8.

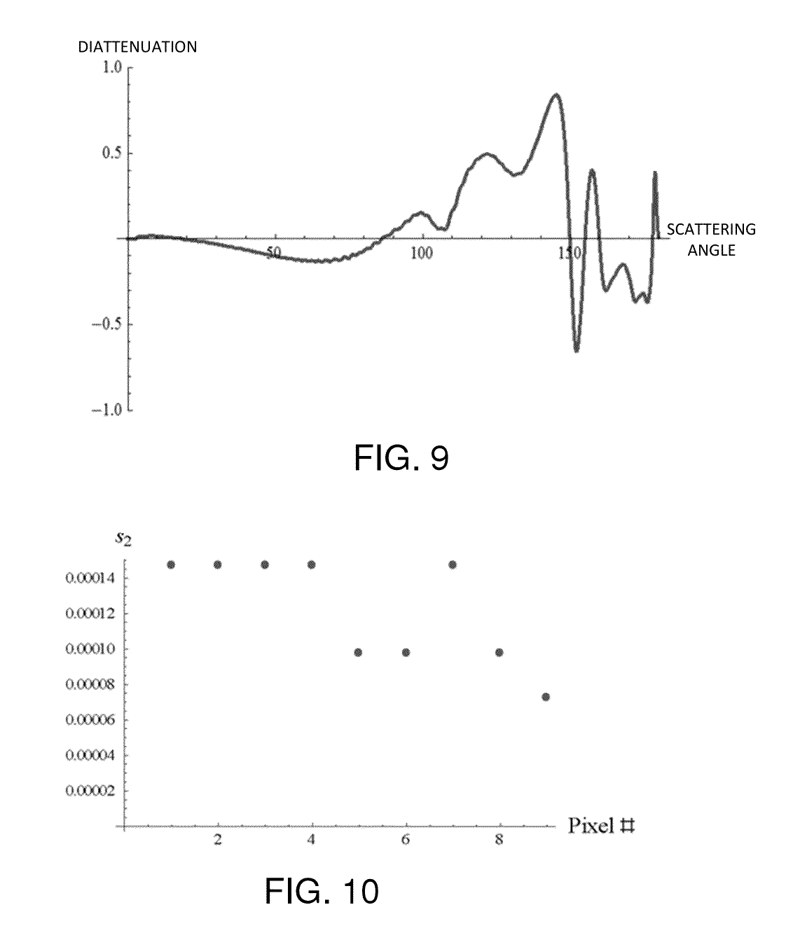

However, the diattenuation along the s-polarization for the backward scattering is greater than that of the forward scattering as shown in FIG. 9. Therefore, the backward scattered light is more polarized than the forward scattered light as shown in FIGS. 6-7.

For rays following path₁, polarization of the scattered light is s-polarized since they experience single scattering. The s-polarization for this example is

ŝ=\hat{k}_{Out}×\hat{k}_{In}={0,−1,1}/\sqrt{0}. (1.6.10)

The s-polarization is linearly polarized light at 45° in the detector's local coordinates. Therefore, S₂ components of the 2D Stokes vectors in Eq. (1.6.8) provide how much of s-polarization exists in the exiting light. FIG. 10 shows the S₂ components of the 2D Stokes vectors at each pixel. Again, the pixels 1, 2, 3, 4, and 7 have the same value.

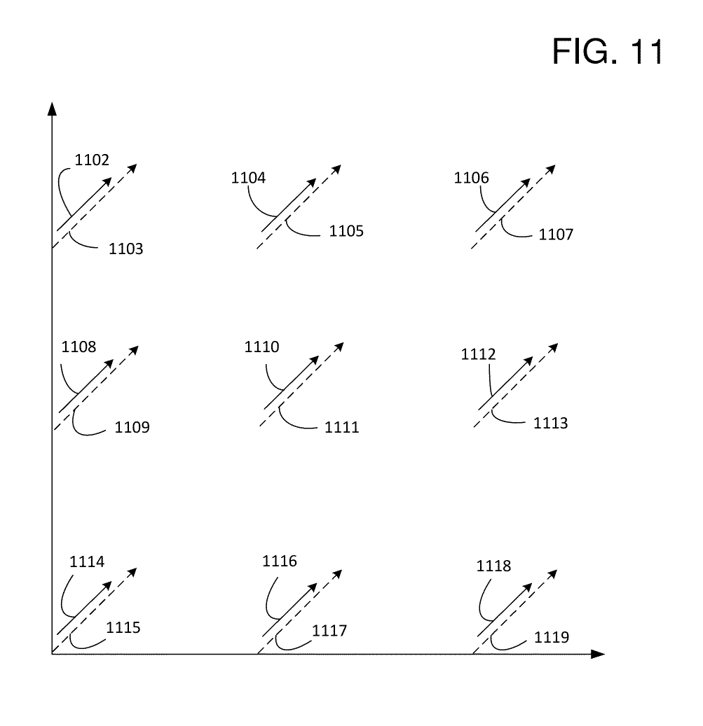

However, S_{Out} at each pixel is incoherent addition of exiting vectors from path₁ and path₂. Therefore, the polarization of the exiting light is not purely s-polarized. FIG. 11 shows the orientation of the exiting light polarization S_{Out} on the detector as solid arrows 1102, 1104, 1106, 1108, 1110, 1112, 1114, 1116, and 1118. Dashed arrows 1103, 1105, 1107, 1109, 1111, 1113, 1115, 1117, and 1119 represent linearly polarized light at 45° on the detector plane. S_{Out} is mostly polarized along 45° with little deviations,

$$orientation = ( \begin{matrix}44.9994 & 44.9970 & 44.9964 \\ 45.0017 & 44.9985 & 45.0203 \\ 45.0023 & 44.9767 & 44.9976\end{matrix} ) . \qquad ( 1.6 .11 )$$

This example can be extended to describe the larger cubical cloud by using more scattering water droplets. Similar example can be setup with different scattering volumes by choosing different refractive index of the scattering particles and the atmosphere. The incident light properties as well as the camera/detector viewing angle can be changed. All the tensor calculation methods that have been used in this example are general and can be modified depending on the assumptions and other conditions of the applications.

### 2. REPRESENTATIVE METHODS

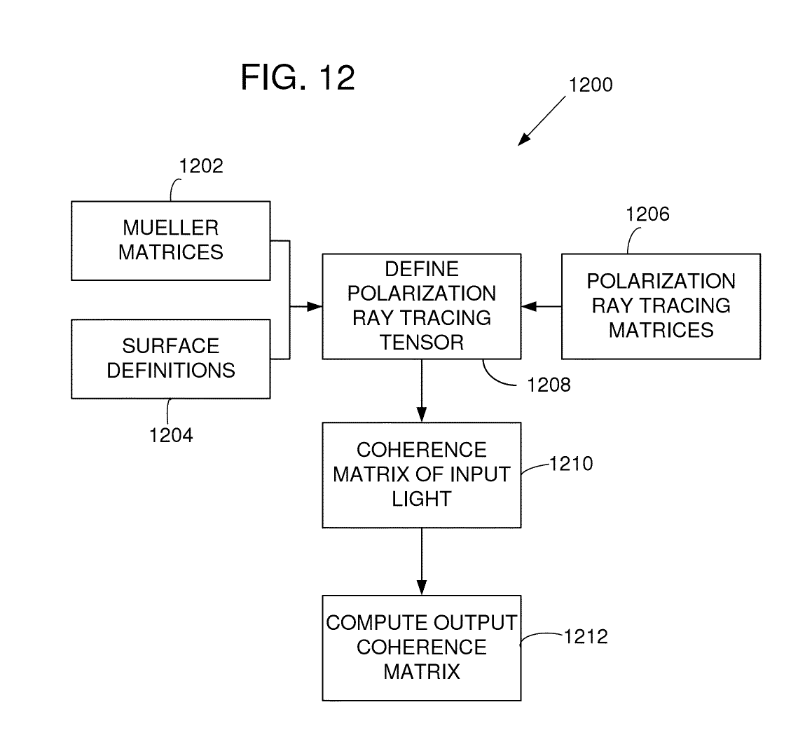

Referring to FIG. 12, a method 1200 includes defining a polarization ray tracing tensor (PRTT) at 1208 based on, for example, Mueller matrices, surface definitions, or polarization ray tracing matrices stored in respective databases 1202, 1204, 1206. Surface definitions are generally provided so that reflectance and/or transmittance as a function of state of polarization can be obtained using, for example, Fresnel coefficients. At 1210, a coherence matrix associated with input light is established, and at 1212, an output coherence matrix is computed. An input light specification can be provided as a coherence matrix, or a coherence matrix can be determined based on, for example, input field vectors.

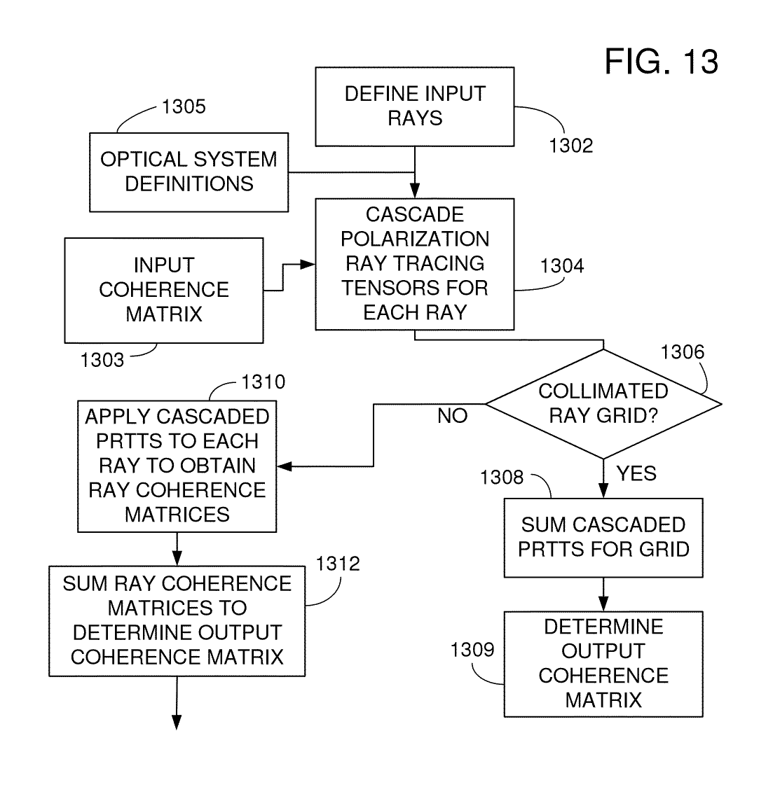

FIG. 13 illustrates a ray tracing method based on the PRTTs. At 1302, one or more input rays are defined, and at 1305, optical system definitions are received. An input coherence matrix is defined at 1303. Surfaces and components of the optical system definition define PRTTs for each surface that are cascaded as 1304 to form cascaded PRTTs for each ray. At 1306, the input ray configuration is assessed. If the input rays form a set of collimated rays, the cascaded PRTTs for the rays are summed at 1308, and used to establish an output coherence matrix at 1309, based on the summed, cascaded PRTTs and an input coherence matrix. For other sets of input rays, cascaded PRTTs are applied to each ray to obtain ray coherence matrices at 1310. The ray coherence matrices are summed at 1312 to establish an output coherence matrix. Square ray grids can be convenient, but other grids such as rectangular, polygonal, arcuate, ellipsoidal, or other arrays of grids can be used.

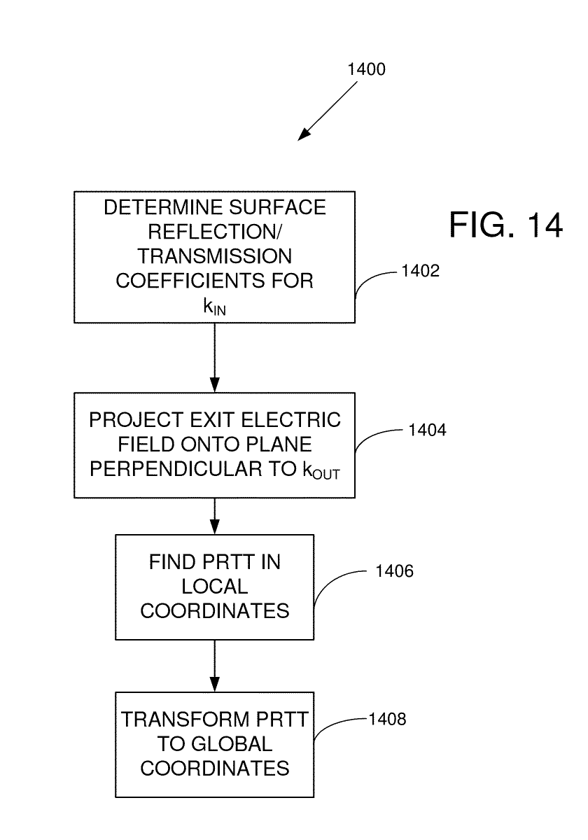

FIG. 14 illustrates a method of determining PRTTs based on Fresnel coefficients. At 1402, surface reflection and/or transmission coefficients are determined based on surface characteristics such as refractive index (real or complex) and incident k vector direction. At 1404, an exit electric field is projected onto a plane perpendicular to an exit k-vector direction. A PRTT in local coordinates is established at 1406 and transformed to global coordinates at 1408.

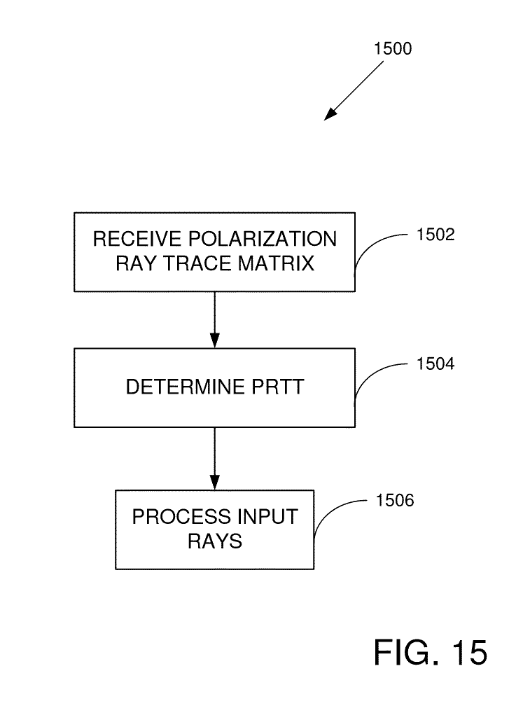

With reference to FIG. 15, a procedure for determining PRTT based on a polarization ray trace matrix (PRTM) includes receiving a PRTM at 1502. At 1504, a PRTT is determined based on a product of elements of the PRTM and complex conjugates of the elements of the PRTM so that t_{i,j,k,l}=P_{i,k}P*_{j,l}, wherein t_{i,j,k,l} is an element of a PRTT, P_{i,k}, P*_{j,l} are elements of a PRTM and a complex conjugates of these elements, and i, j, k, l are positive integers 1, 2, 3.

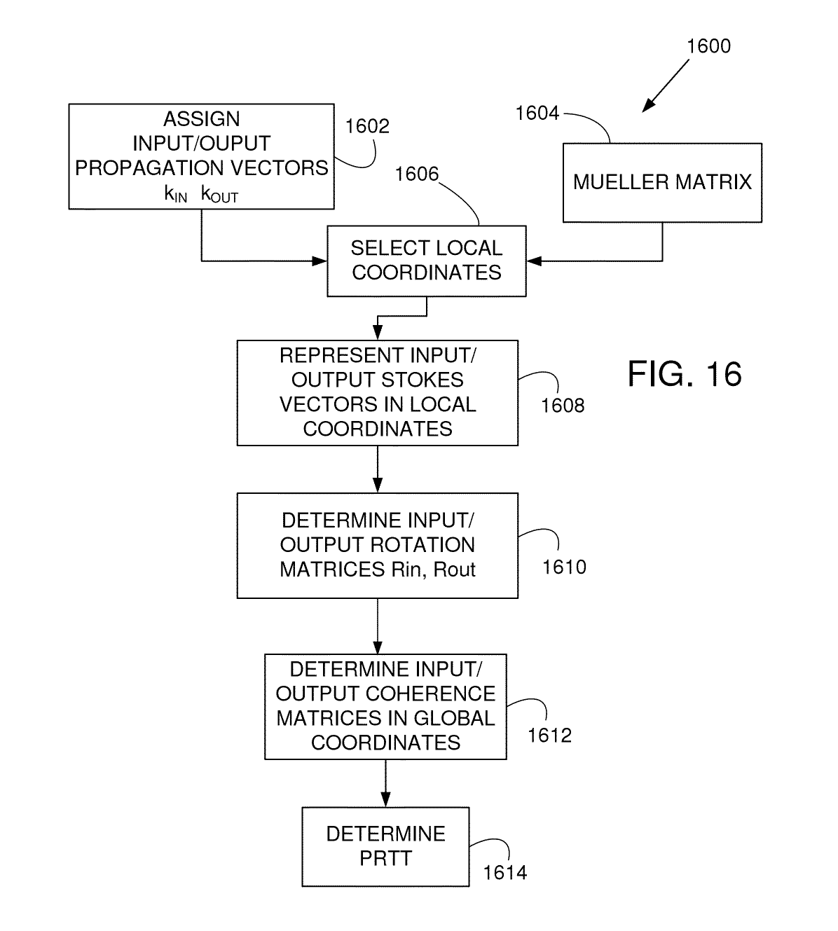

FIG. 16 illustrates a method 1600 of determining a PRTT based on a Mueller matrix associated with an optical system that can be retrieved from a memory at 1604. Input and output propagation vectors or directions are assigned at 1602, and local coordinates are selected at 1606. At 1608, input and output Stokes vectors are defined in the local coordinates, and input and output rotation matrices are defined at 1610. At 1612, input and output coherence matrices in global coordinates are determined, and at 1614, a PRTT in global coordinates is determined.

### 3. IMPLEMENTATION ENVIRONMENT

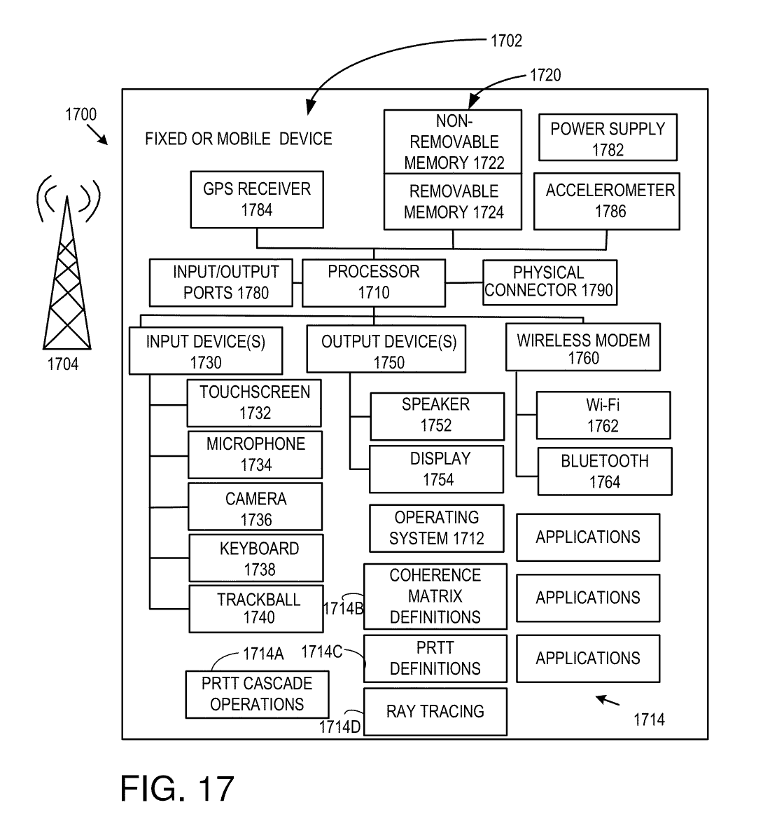

FIG. 17 is a system diagram depicting an exemplary mobile or fixed device 1700 including a variety of optional hardware and software components, shown generally at 1702. Such a system can be used to implement the disclosed methods, alone or in conjunction with additional processing devices. Any components 1702 in the device can communicate with any other component, although not all connections are shown, for ease of illustration. The device can be any of a variety of computing devices (e.g., cell phone, smartphone, handheld computer, Personal Digital Assistant (PDA), etc.), desk top computer, and can allow wireless two-way communications with one or more fixed or mobile communications networks 1704, such as a cellular or satellite network.

The illustrated device 1700 can include a controller or processor 1710 (e.g., signal processor, microprocessor, ASIC, or other control and processing logic circuitry) for performing such tasks as signal coding, data processing, input/output processing, power control, and/or other functions. An operating system 1712 can control the allocation and usage of the components 1702 and support for one or more application programs 1714. The application programs can include common mobile computing applications (e.g., email applications, calendars, contact managers, web browsers, messaging applications), or any other computing application. The application programs can include programs or program components 1714A-1714D are provided for defining polarization ray tracing tensors, calculating of coherence matrices, ray tracing, tensor cascading, and other operations.

The illustrated device 1700 can include memory 1720. Memory 1720 can include non-removable memory 1722 and/or removable memory 1724. The non-removable memory 1722 can include RAM, ROM, flash memory, a hard disk, or other well-known memory storage technologies. The removable memory 1724 can include flash memory or a Subscriber Identity Module (SIM) card, which is well known in GSM communication systems, or other well-known memory storage technologies, such as “smart cards.” The memory 1720 can be used for storing data and/or code for running the operating system 1712 and the applications 1714. Example data can include web pages, text, images, sound files, video data, or other data sets to be sent to and/or received from one or more network servers or other devices via one or more wired or wireless networks. Typically, optical system definitions and the results of ray trace operations are stored in the memory 1720 along with computer-executable instructions for the application programs 1714.

The device 1700 can support one or more input devices 1730, such as a touchscreen 1732, microphone 1734, camera 1736, physical keyboard 1738 and/or trackball 1740 and one or more output devices 1750, such as a speaker 1752 and a display 1754. Other possible output devices (not shown) can include piezoelectric or other haptic output devices. Some devices can serve more than one input/output function. For example, touchscreen 1732 and display 1754 can be combined in a single input/output device. The input devices 1730 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality, systems, all of which provide a more natural interface, as well as technologies for sensing brain activity using electric field sensing electrodes (EEG and related methods). Thus, in one specific example, the operating system 1712 or applications 1714 can comprise speech-recognition software as part of a voice user interface that allows a user to operate the device 1700 via voice commands. Further, the device 1700 can comprise input devices and software that allows for user interaction via a user's spatial gestures, such as detecting and interpreting gestures.

A wireless modem 1760 can be coupled to an antenna (not shown) and can support two-way communications between the processor 1710 and external devices, as is well understood in the art. The modem 1760 is shown generically and can include a cellular modem for communicating with the mobile communication network 1704 and/or other radio-based modems (e.g., Bluetooth 1764 or Wi-Fi 1762).

The device can further include at least one input/output port 1780, a power supply 1782, a satellite navigation system receiver 1784, such as a Global Positioning System (GPS) receiver, an accelerometer 1786, and/or a physical connector 1790, which can be a USB port, IEEE 1394 (FireWire) port, and/or RS-232 port. The illustrated components 1702 are not required or all-inclusive, as any components can be deleted and other components can be added.

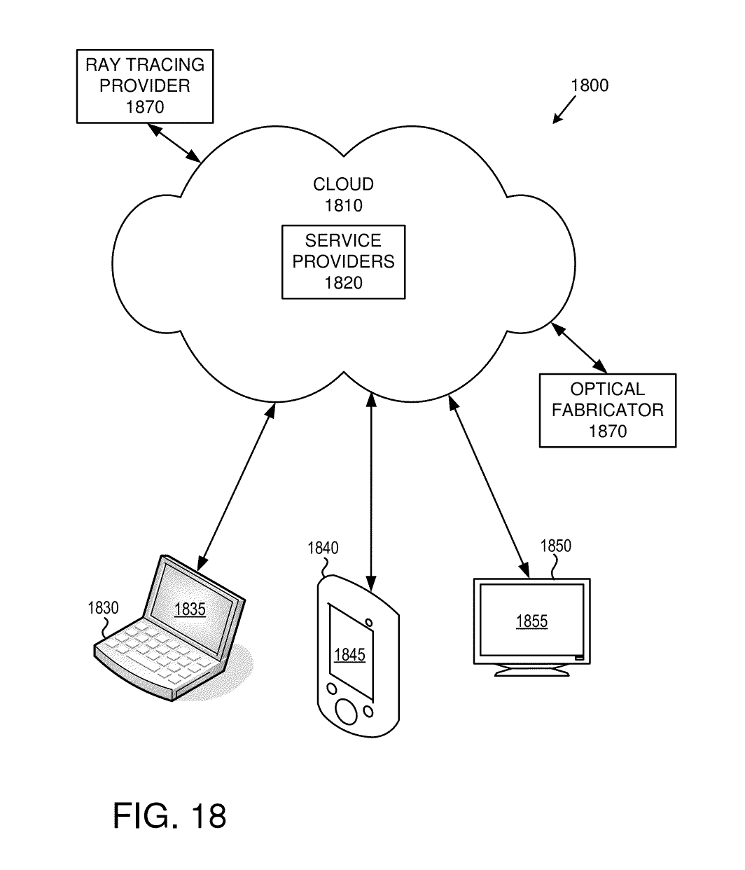

FIG. 18 illustrates a generalized example of a suitable implementation environment 1800 in which described embodiments, techniques, and technologies may be implemented.

In example environment 1800, various types of services (e.g., computing services) are provided by a cloud 1810. For example, the cloud 1810 can comprise a collection of computing devices, which may be located centrally or distributed, that provide cloud-based services to various types of users and devices connected via a network such as the Internet. The implementation environment 1800 can be used in different ways to accomplish computing tasks. For example, some tasks (e.g., processing user input and presenting a user interface) can be performed on local computing devices (e.g., connected devices 1830, 1840, 1850) while other tasks (e.g., storage of data to be used in subsequent processing) can be performed in the cloud 1810. Polarization ray tracing operations, data storage, user inputs and outputs can be distributed throughout the connected computing devices.

In example environment 1800, the cloud 1810 provides services for connected devices 1830, 1840, 1850 with a variety of screen capabilities. Connected device 1830 represents a device with a computer screen 1835 (e.g., a mid-size screen). For example, connected device 1830 could be a personal computer such as desktop computer, laptop, notebook, netbook, or the like. Connected device 1840 represents a device with a mobile device screen 1845 (e.g., a small size screen). For example, connected device 1840 could be a mobile phone, smart phone, personal digital assistant, tablet computer, or the like. Connected device 1850 represents a device with a large screen 1855. For example, connected device 1850 could be a television screen (e.g., a smart television) or another device connected to a television (e.g., a set-top box or gaming console) or the like. One or more of the connected devices 1830, 1840, 1850 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 1800. For example, the cloud 1810 can provide services for one or more computers (e.g., server computers) without displays.

Services such as ray tracing services can be provided by the cloud 1810 through service providers 1820 such as ray tracing provider 1870, or through other providers of services such as a n optical fabricator 18770. Some cloud services can be customized to the screen size, display capability, and/or touchscreen capability of a particular connected device (e.g., connected devices 1830, 1840, 1850).

In example environment 1800, the cloud 1810 provides the technologies and solutions described herein to the various connected devices 1830, 1840, 1850 using, at least in part, the service providers 1820. For example, the service providers 1820 can provide a centralized solution for various cloud-based services. The service providers 1820 can manage service subscriptions for users and/or devices (e.g., for the connected devices 1830, 1840, 1850 and/or their respective users).

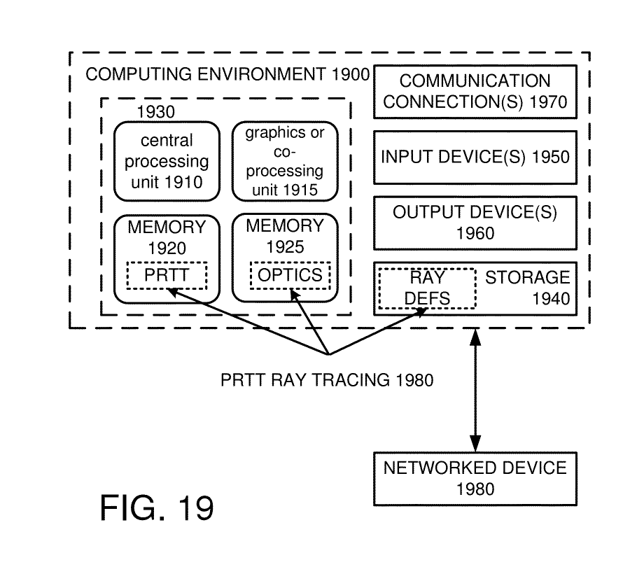

FIG. 19 depicts a generalized example of a suitable computing environment 1900 in which the described innovations may be implemented. The computing environment 1900 is not intended to suggest any limitation as to scope of use or functionality, as the innovations may be implemented in diverse general-purpose or special-purpose computing systems. For example, the computing environment 1900 can be any of a variety of computing devices (e.g., desktop computer, laptop computer, server computer, tablet computer, media player, gaming system, mobile device, etc.)

With reference to FIG. 19, the computing environment 1900 includes one or more processing units 1910, 1915 and memory 1920, 1925. In FIG. 19, this basic configuration 1930 is included within a dashed line. The processing units 1910, 1915 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 19 shows a central processing unit 1910 as well as a graphics processing unit or co-processing unit 1915. The tangible memory 1920, 1925 may be volatile memory (e.g., registers, cache, RAM), non-volatile memory (e.g., ROM, EEPROM, flash memory, etc.), or some combination of the two, accessible by the processing unit(s). The memory 1920, 1925 stores software 1980 implementing one or more innovations described herein, in the form of computer-executable instructions suitable for execution by the processing unit(s). Examples include defining polarization ray trace tensor definitions, ray trace operations, tensor cascade operations, and storage of optical system characteristics such as surface shapes, spacings, refractive indices, device Mueller matrices, scattering functions, and ray definitions, as well as procedures for computation of coherence matrices.

A computing system may have additional features. For example, the computing environment 1900 includes storage 1940, one or more input devices 1950, one or more output devices 1960, and one or more communication connections 1970. An interconnection mechanism (not shown) such as a bus, controller, or network interconnects the components of the computing environment 1900. Typically, operating system software (not shown) provides an operating environment for other software executing in the computing environment 1900, and coordinates activities of the components of the computing environment 1900.

The tangible storage 1940 may be removable or non-removable, and includes magnetic disks, magnetic tapes or cassettes, CD-ROMs, DVDs, or any other medium which can be used to store information in a non-transitory way and which can be accessed within the computing environment 1900. The storage 1940 stores instructions for the software 1980 implementing one or more innovations described herein.

The input device(s) 1950 may be a touch input device such as a keyboard, mouse, pen, or trackball, a voice input device, a scanning device, or another device that provides input to the computing environment 1900. For video encoding, the input device(s) 1950 may be a camera, video card, TV tuner card, or similar device that accepts video input in analog or digital form, or a CD-ROM or CD-RW that reads video samples into the computing environment 1900. The output device(s) 1960 may be a display, printer, speaker, CD-writer, or another device that provides output from the computing environment 1900.

The communication connection(s) 1970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Any of the disclosed methods can be implemented as computer-executable instructions stored on one or more computer-readable storage media (e.g., one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

### 4. CONCLUSION

Algorithms for the incoherent polarization ray tracing through depolarizing and non depolarizing optical systems are described. A coherence matrix of the incident ray's electric field vector (³Φ_{In}) and a coherence matrix of the exiting ray's electric field vector (³Φ_{Out}) at q^{th} ray intercept are related by a polarization ray tracing tensor, T_{q} by Eq. (1.4.2). By cascading the polarization ray tracing tensors as shown in Eq. (1.4.6), the electric field vector's coherence matrix at the exit pupil or a detector can be calculated from the coherence matrix of the incident electric field vector at the entrance pupil or the source. Since ³Φ_{In}, ³Φ_{Out}, and T_{q} are defined in global coordinates, incoherent addition of the coherence matrices or polarization ray tracing tensors are more straightforward, and therefore much less error prone, than adding 2D Stokes parameters or Mueller matrices, where each vector or matrix is described in different local coordinates. As shown in Eq. (1.4.7), the polarization ray tracing tensor is not restricted by a single \hat{k}_{Out}, which is a critical characteristic for dealing with scattering or stray light analysis.

1. A computer implemented method of polarization ray tracing, comprising:
receiving a polarization ray tracing tensor (PRTT) for an optical system; and
based on the PRTT, characterizing propagation of light through the optical system along at least one ray path.

2. The method of claim 1, further comprising defining the PRTT based on at least one of a Mueller matrix, an optical surface characteristic, or a polarization ray tracing matrix associated with the optical system.

3. The method of claim 1, wherein the PRTT is defined for a plurality of optical surfaces by cascading PRTTs for each of the surfaces so that the PRTT is a cascaded PRTT.

4. The method of claim 1, further comprising applying the PRTT to an input coherence matrix to establish an output coherence matrix associated with propagation through the optical system.

5. The method of claim 4, further comprising defining PRTTs for each ray of a grid of rays and obtaining the output coherence matrix by applying respective PRTTs to each of the rays of the grid of rays.

6. The method of claim 5, wherein each of the PRTTs associated with the rays of the grid of rays is a cascaded PRTT associated with a plurality of surfaces, and the output coherence matrix is established by applying the PRTTs to each of the rays of the grid of rays.

7. The method of claim 5, wherein each of the PRTTs associated with the rays of the grid of rays is a cascaded PRTT associated with a plurality of surfaces, and the output coherence matrix is established by applying the PRTTs to each of the rays of the grid of rays to obtain ray coherence matrices, and the output coherence matrix is established by summing the ray coherence matrices.

8. The method of claim 5, wherein each of the PRTTs associated with the rays of the grid of rays is a cascaded PRTT associated with a plurality of surfaces, and the output coherence matrix is established by summing the cascaded PRTTs associated with the rays, and applying the summed, cascaded PRTTs to the input coherence matrix.

9. The method of claim 1, wherein the PRTT is defined with respect to a global coordinate system.

10. A computer readable medium containing computer executable instructions for a method comprising:
obtaining an optical system definition; and
defining at least one polarization ray tracing tensor (PRTT) based on an optical system definition.

11. The computer readable medium of claim 10, further comprising applying the PRTT to an input coherence matrix to obtain an output coherence matrix.

12. The computer readable medium of claim 10, further comprising characterizing a polarization property of the defined optical system with respect to at least one ray path, wherein the polarization property is diattenuation, retardance, depolarization, or a combination thereof.

13. The computer readable medium of claim 10, wherein the PRTT is defined based on Fresnel coefficients associated with reflectance or transmittance at at least one optical surface.

14. The computer readable medium of claim 13, wherein the PRTT is defined in global coordinates by applying a coordinate transformation defined by directions associated with a ray propagation direction, a ray s-polarization direction, and a ray p-polarization direction.

15. The computer readable medium of claim 14, wherein the coordinate transformation corresponds to application of a rotation matrix defined by a ray propagation direction, a ray s-polarization direction, and a ray p-polarization direction.

16. The computer readable medium of claim 10, wherein the PRTT is defined by projecting an exit electric field vector onto a plane perpendicular to an output propagation direction.

17. The computer readable medium of claim 10, wherein the PRTT is defined by a polarization ray tracing matrix (PRTM), wherein elements of the PRTT correspond to products of elements of the PRTM and elements of a complex conjugate of the PRTM.

18. The computer readable medium of claim 17, wherein t_{i,j,k,l}=P_{i,k}P*_{j,l}, wherein t_{i,j,k,l} is an element of a PRTT, P_{i,k},P*_{j,l} are an element of the PRTM and a complex conjugate of an element of the PRTM, and i, j, k, l are positive integers 1, 2, 3.

19. The computer readable medium of claim 10, wherein the PRTT is defined in a global coordinate system by obtaining an output coherence matrix in a local coordinate system based on a Mueller matrix associated with the optical system definition, input and output Stokes vectors, and transforming the output coherence matrix in the local coordinate system to a global coordinate system using rotation matrices associated with an output propagation direction.

20. The computer readable medium of claim 10, wherein the optical system definition includes a plurality of surfaces and the PRTT is defined by cascading individual PRTTs associated with each of the plurality of surfaces.

21. An optical design system, comprising:
a memory storing a definition of an optical system; and
a processor coupled to the memory and configured to determine a polarization ray tracing tensor based on the optical system definition for at least one path through the defined optical system.

22. The optical design system of claim 19, wherein the processor is configured to:
transform a polarization ray tracing tensor from a local coordinate system to a global coordinate system, wherein the local coordinate system is based on an s-polarization direction, a p-polarization direction, and an incident propagation direction;
cascade a plurality of polarization ray tracing tensors to form a cascaded polarization ray tracing tensor; and
based on the cascaded polarization ray tracing tensors, characterize a polarization property of the defined optical system with respect to the at least one ray path, wherein the polarization property is diattenuation, retardance, depolarization, or a combination thereof, or determine an output coherence matrix as a product of the cascaded polarization ray tracing tensor and an input coherence matrix.
